(19) United States
(12) Patent Application Publication
(10) Pub. No.: US 2025/0187988 A1
(43) Pub. Date: Jun. 12, 2025

(54) HIERARCHICAL STRUCTURES AND METHODS OF MANUFACTURE THEREOF

(71) Applicant: NELUMBO INC., HAYWARD, CA (US)

(72) Inventors: Lance R. Brockway, Hayward, CA (US); David C. Walther, Hayward, CA (US); Brian P. Sweeney, Hayward, CA (US)

(21) Appl. No.: 18/844,919

(22) PCT Filed: Mar. 8, 2023
(86) PCT No.: PCT/US2023/014779

§ 371 Date: Sep. 6, 2024

Related U.S. Application Data
(60) Provisional application No. 63/318,207, filed on Mar. 9, 2022.

(51) Int. Cl. C04B 35/622; C04B 41/00; C04B 41/50; C04B 41/53

(52) U.S. Cl. CPC C04B 35/62222; C04B 41/0072; C04B 41/5072; C04B 41/5307; C04B 2235/5454

(57) ABSTRACT

Compositions are provided that include a porous first material and a particulate second material that at least partially fills the pores of the first material. Methods of producing the compositions are also provided.

### CROSS-REFERENCE TO RELATED APPLICATIONS

This application claims the benefit of U.S. Provisional Application No. 63/318,207, filed on Mar. 9, 2022, which is incorporated by reference herein in its entirety.

### FIELD OF THE INVENTION

The invention relates to coating or surface modification materials and methods of surface modification, in particular materials that have a hierarchical structure that provides one or more beneficial physical or chemical properties when integrated with a substrate in comparison to the substrate without the hierarchical structure.

### BACKGROUND

Surface modification technologies have been employed for use in a variety of fields for many years. Many of these applications employ an intermediate layer to improve the durability of the coating. A classic example is the use of primer to clean and treat the substrate prior to painting.

Modern surface modification technologies and coating systems, such as painting, primers, conversion coatings, powder coating, plating and the application of other coating materials, are designed for aesthetics, corrosion resistance, cleanability and many other features of interest. The application of these coatings can be carried out using a variety of methods including contact painting (brush), spray painting, dip coating, and roller coating, to name a few. The common desired trait among these methods is to ensure a good adhesion of the applied coating to the substrate. In order to do this, typically large loose debris is removed, and surface dirt and grime is removed with one or more cleaning steps. Then, a single or series of surface treatment processing steps is applied, and a final functional coating may be applied in one or more steps. Subsequent processing such as baking, curing, or other steps may be carried out to improve the adhesion or functionality of the surface. Most commonly, modern coating systems comprise several processes that use some form of a binder to apply, organize and adhere the coating materials to the substrate. Many systems also rely on applied electrical potentials to either accelerate the process or adhere the materials to the substrate being modified or both.

More recently, surface modification technologies are being developed for applications beyond surface protection from corrosion and other environmental inputs. These applications can include a more functional usage goal such as electrical field modulation, surface wettability, catalytic and photocatalytic activity, anti-microbial properties, phase change materials, and even aesthetic purposes such as color changing. These modern applications often require the inclusion of functional materials such as structural dyes, specific catalytic activity, or surface energy modifiers, to name a few.

Several approaches are described in the literature to even further enhance the resulting surface, which rely on one or more lithographic patterning steps and/or directed energy patterning techniques such as laser scanning, or electron or ion beams.

Further, in conjunction with these developments, improved methods of manufacturing and surface characterization are making it possible to impart structural and morphological changes that provide additional benefits to traditional chemical or electrical interactions, in order to further modify wettability, radiative heat transfer, conductive heat transfer, electrical flow, and fluid surface interactions.

In addition, concern for the environment is leading to the development of benign processing steps and materials in order to reduce the presence of fluorocarbons and volatile organic compounds (VOC), both of which lead to poor indoor and environmental air quality. Environmental and health impacts of perfluoroalkyl and polyfluoroalkyl substances (pfas) are better understood and the use of these materials is being restricted. Further, environmental and human health concerns are pushing industry to adopt alternate technologies for the production of plastics and resins, such as coatings which are typically applied in dip-coat fashion to the exterior of packaging, air conditioning, automotive, and other surfaces.

There is often a desire for reduced weight, which favors high strength to weight materials such as aluminum for transportation and consumer device applications. Thinner, robust coatings that promote good adhesion and corrosion resistance are highly desirable. Further, conformal deposition and favorable resulting wetting properties are desirable for components with high aspect ratio or complex designs which include features with small characteristic dimension.

Finally, to reduce overall cost, it is desirable to have a simple and scalable process, such as is practiced in the surface treatment of automotive components. A surface treatment process that may be carried out in batch or continuous processing steps at any scale is desirable.

### BRIEF SUMMARY OF THE INVENTION

Hierarchical compositions and methods of producing the compositions are described herein.

In one aspect, a composition is provided that includes a substrate, a first material, and a second material, wherein the first material includes a porous, nanostructured ceramic and the second material includes particles, wherein the second material at least partially occupies the pores of the first material, and wherein the substrate is in contact with at least a portion of the first material. In some embodiment, the substrate includes a metal, a ceramic, or a polymer. For example, the substrate may include a metal including aluminum, iron, zinc, manganese, magnesium, copper, nickel, vanadium, and/or silicon, a ceramic including aluminum, iron, zinc, silicon, oxygen, and/or carbon, or a polymer including aluminum, silicon, oxygen, nitrogen, phosphorous, sulfur, fluorine, and/or carbon. In some embodiments, the substrate and the second material comprise at least one common element. For example, the at least one common element may include one or more of Cu, Mn, Fe, Al, Si, Zn, Mg, Ti, Ni, and Zr.

In another aspect, a composition is provided that includes a first material and a second material, wherein the first material includes a porous, nanostructured ceramic and the second material includes particles, wherein the second material at least partially occupies the pores of the said first material, and wherein the first material is in contact with at least a portion of the second material.

In some embodiments of the compositions described herein, the first material and/or the second material comprises a metal oxide, a metal hydroxide, or a layered double hydroxide.

In some embodiments of the compositions described herein, the first material includes a transition metal, an alkaline earth metal, or a rare earth metal. In some embodiments, the first material and/or the second material includes zinc, iron, manganese, magnesium, calcium, nickel, or cerium.

In some embodiments of the compositions described herein, the second material includes any of Sc, Ti, V, Cr, Mn, Fe, Co, Ni, Cu, or Zn, any of Y, Zr, Nb, Mo, Tc, Ru, Rh, Pd, Ag, or Cd, or any of Lu, Hf, Ta, W, Re, Os, Ir, Pt, Au, or Hg, and/or any of Lr, Rf, Db, Sg, Bh, Hs, Mt, Ds, Rg, or Cn.

In some embodiments of the compositions described herein, the second material includes any of Ca, Mg, Ba, Sc, Li, Be and an associated phosphate, carbonate, oxalate, fluoride, or sulfate. In some embodiments of the compositions described herein, the second material includes particles of precipitation reaction products or aggregates of precipitation reaction products.

In some embodiments of the compositions described herein, the first material has a thickness of about 10 nanometers to about 200 micrometers. For example, at least a portion of the first material may have thickness of about 20 nanometers to about 50 micrometers.

In some embodiments of the compositions described herein, the second material includes particles with a characteristic dimension less than about 20 micrometers, less than about 10 micrometers, less than about 5 micrometers, less than 2 micrometers, less than 1 micrometer, less than 500 nanometers, less than about 250 nanometers, or less than about 100 nanometers.

In some embodiments of the compositions described herein, at least a portion of the second material has a thickness of about 10 nanometers to about 20 micrometers, or a thickness of about 20 nanometers to about 20 micrometers.

In some embodiments of the compositions described herein, the second material includes particles of aluminum oxides, aluminum oxide-hydroxides, mixed oxide phases, aluminum chalcogenides, aluminum pnictides. In some embodiments, the second material includes silica, fumed silica, a silicone, a silane, a siloxane, a polysiloxane, a silazane, or a polysilazane. In some embodiments, the second material includes particles of aluminum oxides, including alumina, corundum, α-alumina, γ-alumina; aluminum oxide-hydroxides, including boehmite, diaspore, or aluminum trihydroxides, bayerite, gibbsite, nordstrandite; or mixed oxide phases, including spinel (MgAl₂O₄), Na-β-alumina (NaAl₁₁O₁₇), tricalcium aluminate (Ca₃Al₂O₆). In some embodiments, the second material includes particles of aluminum chalcogenides, including aluminum sulfide (Al₂S₃), aluminum selenide (Al₂Se₃), or aluminum telluride (Al₂Te₃). In some embodiments, the second material includes particles of aluminum pnictides, including aluminum nitride (AlN), aluminum phosphide (AIP), aluminum arsenide (AlAs), or aluminum antimonide (AlSb). In some embodiments, the second material includes particles of precipitation reactions, including calcium phosphate, calcium carbonate, calcium oxalate, or calcium sulfate.

In some embodiments of the compositions described herein, the interface between the first material and the second material is a gradient.

In some embodiments of the compositions described herein, the composition further includes a hydrophobic compound with a polar head group and a non-polar tail group that includes an alkyl group, a methyl group, a fluoroalkyl group, a perfluoroalkyl group, a vinyl group, a phenyl group, a substituted alkyl group, or an aryl group.

In some embodiments of the compositions described herein, the composition is charactered by a sessile drop water contact angle above 150 degrees.

In some embodiments of the compositions described herein, the composition includes about 5%, about 5% to about 10%, about 5% to about 20%, about 5% to about 40%, about 5% to about 50%, about 5% to about 75%, about 5% to about 90%, about 5% to about 95%, about 5% to about 99%, about 50% to about 60%, about 50% to about 70%, about 50% to about 80%, about 50% to about 90%, about 50% to about 95%, about 50% to about 99%, about 10 to about 20%, about 20 to about 30%, about 30% to about 40%, about 40% to about 50%, about 50% to about 60%, about 60% to about 70%, about 70% to about 80%, about 80% to about 90%, about 90% to 99% reduction in defrost energy requirement to remove frost which has formed when compared to a similarly frosted, but untreated substrate.

In some embodiments of the compositions described herein, the first material includes a porous, nanostructured ceramic with morphological features of nanowalls, and the second material comprises a morphology comprising at least one of spheres, rods, plates, needles, sheets, grains, spheres with colpi, polyhedra, toroidal shapes, stellated shapes, and conical sections.

In another aspect, a method is provided for producing a composition as described herein. The method includes: (a) dipping a cleaned substrate into an aqueous bath containing at least one metal salt and an amine to produce a ceramic crystal structure on the surface, thereby producing a coated substrate comprising the first material deposited on the substrate, (b) placing the coated substrate into a nanoparticle dispersion of an insoluble oxide or hydroxide of a metal or a metalloid, thereby producing the second material deposited on the first material, (c) removing the coated substrate from the nanoparticle dispersion and baking it to remove water from the substrate and ceramic surface, and (d) making the coated substrate hydrophobic by coating the coated substrate with a hydrophobic compound. In some embodiments, the oxide or hydroxide in (b) is selected from titanium oxide, aluminum oxide, aluminum hydroxide, silica, zinc oxide, iron oxide, zirconium dioxide, and manganese oxide. In some embodiments, the number average diameter of the nanoparticles in the nanoparticle dispersion is about 50 nm to about 50 μm.

In another aspect, a method is provided for producing a composition as described herein. The method includes: (a) dipping a cleaned substrate into an aqueous bath containing at least one metal salt and an amine to produce a ceramic crystal structure on the surface, thereby producing a coated substrate comprising the first material deposited on the substrate, (b) placing the coated substrate in contact with a precipitation reaction reagent to distribute the reagent throughout at least a portion of the first material, and then placing the coated substrate in contact with a second precipitation reaction reagent, (c) removing the coated substrate from the precipitation reagent containing solutions, and drying it to remove water from the substrate and ceramic surface, and (d) making the coated substrate hydrophobic by coating the coated substrate with a hydrophobic compound. In some embodiments, one of the precipitation reagents comprises a metal salt and the other precipitation reagent containing solution comprises a complementary cation comprising phosphate, carbonate, oxalate, fluoride, or sulfate. In some embodiments, the number average diameter of the nanoparticles in the precipitation reaction is about 50 nm to about 50 μm.

In another aspect, a method is provided for producing a composition as described herein. The method includes: (a) dipping a cleaned substrate into an aqueous bath containing at least one metal salt, and an amine to produce a ceramic crystal structure on the surface, thereby producing a coated substrate comprising the first material on the substrate, removing the coated substrate from the bath and baking it to remove water from the substrate and ceramic structure, (b) placing the coated substrate into a different aqueous bath containing at least one metal salt and an amine to produce a ceramic crystal structure on the surface, thereby producing the second material deposited on the first material (c) removing the coated substrate from the bath and baking it to remove water from the substrate and ceramic surface, and (d) making the coated substrate hydrophobic by coating the coated substrate with a hydrophobic compound. In one embodiment, the metal salts in (a) and (b) are the same. In another embodiment, the metal salts in (a) and (b) are different. In some embodiments, the metal in the metal salts includes zinc, manganese, cobalt, nickel, aluminum, copper, iron, magnesium, titanium, or zirconium. In some embodiments, the crystallization conditions of the method include different time, concentrations and/or temperature in the aqueous baths in (a) and (b).

In another aspect, a method is provided for producing a composition as described herein. The method includes: (a) dipping a cleaned substrate into an aqueous bath containing at least one metal salt, and an amine to produce a ceramic crystal structure on the surface, thereby producing a coated substrate comprising the first material on the substrate, optionally removing the coated substrate from the bath and baking it to remove water from the substrate and ceramic structure, (b) spraying the substrate and first material with, contacting the first material with, or immersing the substrate and first material into a particulate containing solution, at a temperature of about 20° C. to about 90° C. for a duration of about 30 seconds to about 2 hours such that particulate aggregates are deposited wherein at least a portion of the second material partially occupies the void space of the first material, (c) removing the coated substrate from the bath and baking it to remove water from the substrate and ceramic surface, and (d) making the coated substrate hydrophobic by coating the coated substrate with a hydrophobic compound.

### BRIEF DESCRIPTION OF THE DRAWINGS

FIG. 1 is a schematic representation of a composite material as described herein.

FIG. 2 shows different forms of particles as described herein, for example, particles of second material as described herein. 2A: round/spherical; 2B: aggregates/amorphous structures; 2C: faceted/crystalline; 2D: cylindrical/rod/whiskers

FIG. 3 shows examples of a substrate and a first material, as described herein. 3A: interconnected structure with pores; 3B: whisker-like structure; 3C: faceted platelike structure

FIG. 4 shows examples of a substrate and a first material with partial occupation and with large and small particle occupation by a second material. 4A: partial occupation; 4B: small particle occupation; 4C: large particle occupation

FIG. 5 shows examples of a substrate, a first material, and a second material. 5A: interconnected first and second material structure with pores; 5B: whisker-like first and second material structure; 5C: faceted platelike first material structure with whisker-like second material

FIG. 6 shows examples of a substrate, a first material, and a second material. 6A: interconnected first material structure with pores and a whisker-like second material (same composition); 6B: interconnected first material structure with pores and whisker-like second material (different compositions); 6C: whisker-like first material and particulate second material (same composition); 6D: whisker-like first material and particulate second material (different compositions)

FIG. 7 shows examples of a substrate, a first material, and a second material. 7A: interconnected first material structure with pores and conformal second material; 7B: interconnected first material structure with pores and particulate second material (same composition); 7C: interconnected first material structure with pores and particulate second material (different compositions)

FIG. 8 shows examples of a substrate, a first material, and a second material. 8A: interconnected first material structure with pores and spherical particulate second material occupied within the first material; 8B: interconnected first material structure with pores and particulate second material (same composition) with whiskers attached to second material; 8C: interconnected first material structure with pores and cylindrical second material occupied within the first material

FIG. 9 shows an example of a substrate, an interconnected cylindrical first material structure, and a particulate second material occupied within the first material,

FIG. 10 shows examples of a substrate with macro design features, a first material, and a second material. 10A: interconnected first material structure with pores and a whisker-like second material in a reentrant macrostructure; 10B: interconnected cylindrical first material structure with pores and a whisker-like second material in a non-reentrant macrostructure

FIG. 11 shows examples of a substrate with macro design features, a first material, and a second material. 11A: interconnected cylindrical whisker first material structure with pores and a particulate second material in a reentrant macrostructure; 11B: interconnected cylindrical whisker first material structure with pores and a particulate second material in a non-reentrant macrostructure

FIG. 12 shows a scanning electron micrograph (SEM) image of a nanostructured, hierarchical material on an aluminum substrate. The primary features are nanoplates with characteristic feature sizes of 2-6 μm. The nanoplates have hemispherical caps on the edges and faces of the plates with characteristic feature size of 100 nm. The primary features of the plates were grown via chemical bath deposition, at one set of parameters, and the secondary features were grown via chemical bath deposition at different growth conditions than the primary features. Both the primary and secondary features contain manganese and aluminum oxides.

FIG. 13 shows a SEM image of a nanostructured hierarchical material on an aluminum substrate. The primary features are nanoplates with characteristic feature sizes of 2-6 μm and are composed of manganese and aluminum oxides. The nanoplates have spherical particles of fumed silica intruding into the pores with characteristic feature sizes of 1-4 μm. The primary features of the plates were grown via chemical bath deposition. The secondary features were formed via immersion of the primary structure into a nanoparticle dispersion of fumed silica.

FIG. 14 shows a SEM image of a nanostructured, hierarchical material on an aluminum substrate. The primary features are nanoplates with characteristic feature sizes of 2-6 μm. The nanoplates have nanorods on the edges and faces of the plates with characteristic feature size of 100-500 nm. The primary features of the plates were grown via chemical bath deposition, at one set of parameters, and the secondary features were grown via chemical bath deposition at different growth conditions than the primary features. Both the primary and secondary features are mixtures of manganese and aluminum oxides

FIG. 15 shows a SEM image of a nanostructured, hierarchical material on an aluminum substrate. The primary features are nanoplates with characteristic feature sizes of 2-6 μm and are composed of a mixture of zinc and aluminum oxides. The nanoplates have stellated nanoparticles intruding into the pores and otherwise bound to the nanostructure with characteristic dimensions of 50-200 nm and are composed of hydroxyapatite. The primary features of the plates were grown via chemical bath deposition, and the secondary features were grown via a precipitation reaction inside the pores.

FIG. 16 shows a SEM image of a nanostructured, hierarchical material on an aluminum substrate. The primary features are nanoplates with characteristic feature sizes of 2-6 μm. The nanoplates have nanoplates which are grown out of the surface and intrude significantly into the porous structure of the primary material. The primary features of the plates were grown via chemical bath deposition, and the secondary features were generated via a recrystallization and conversion reaction. Both the primary features and secondary features are composed of a mixture of magnesium and aluminum layered double hydroxides.

FIG. 17 shows an example of a first material and second material that are not connected to a substrate, where the first material has primary features of interconnected cylindrical whiskers and the second material has primary features of particulates.

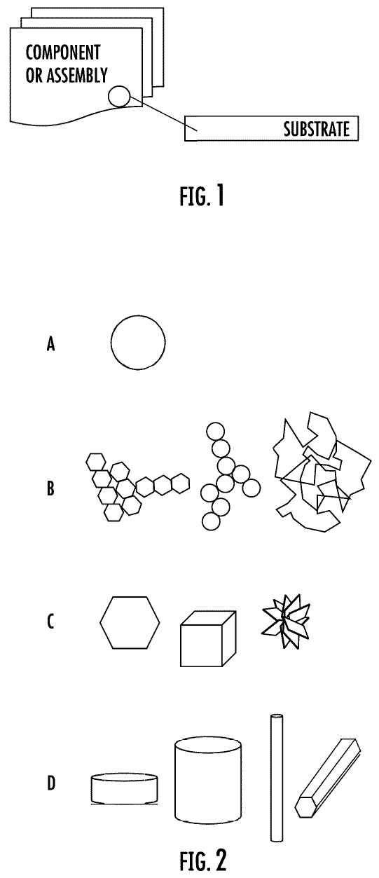

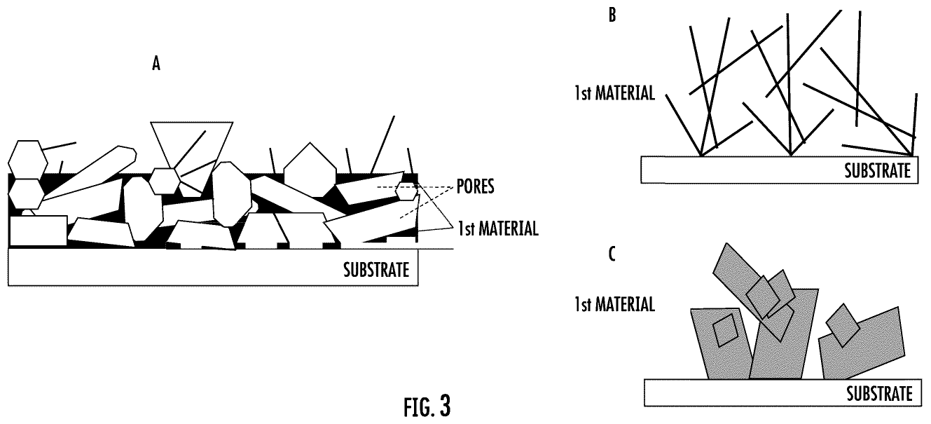

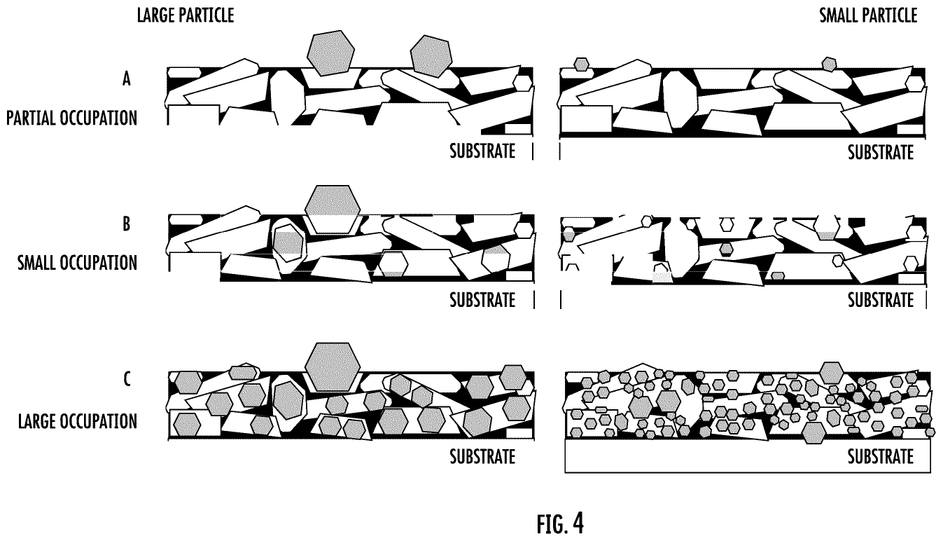

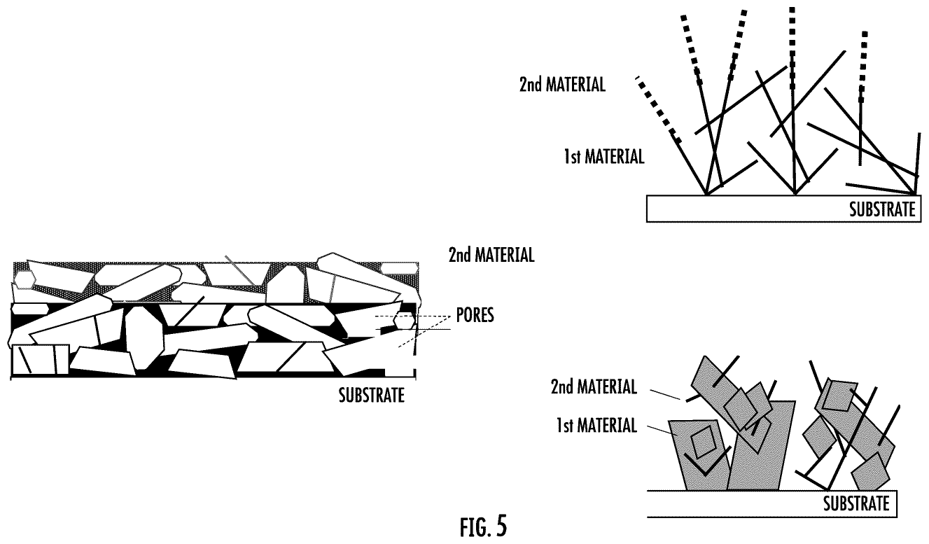

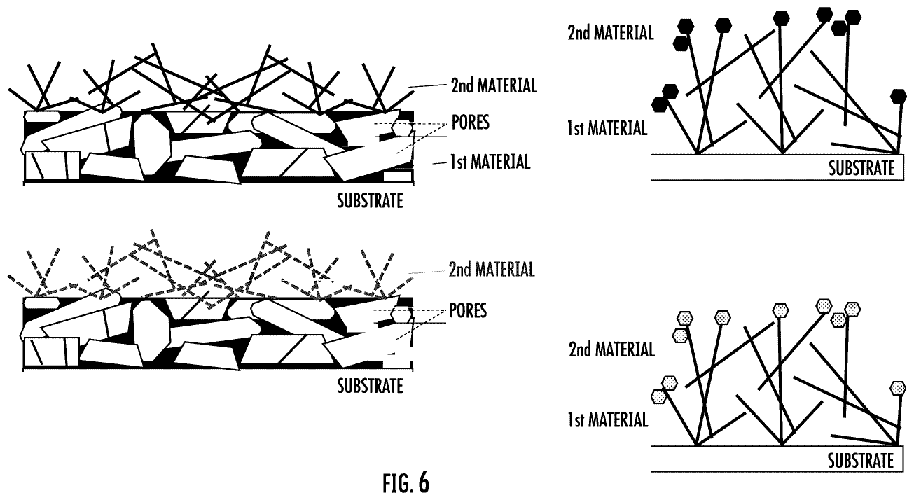

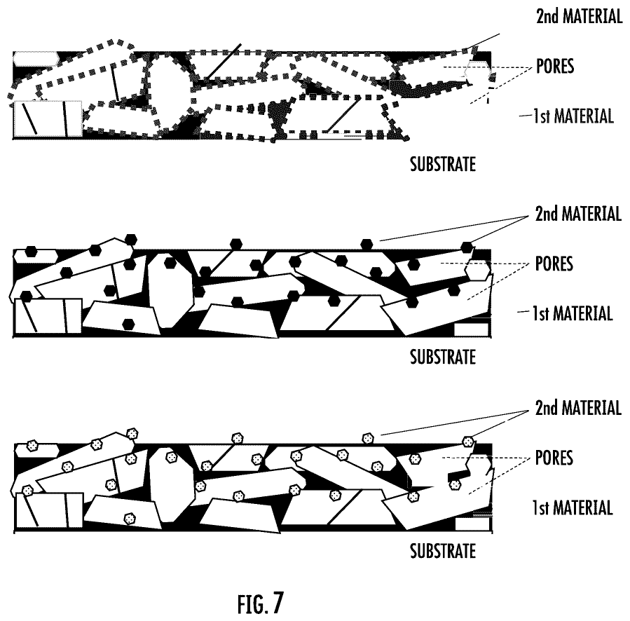

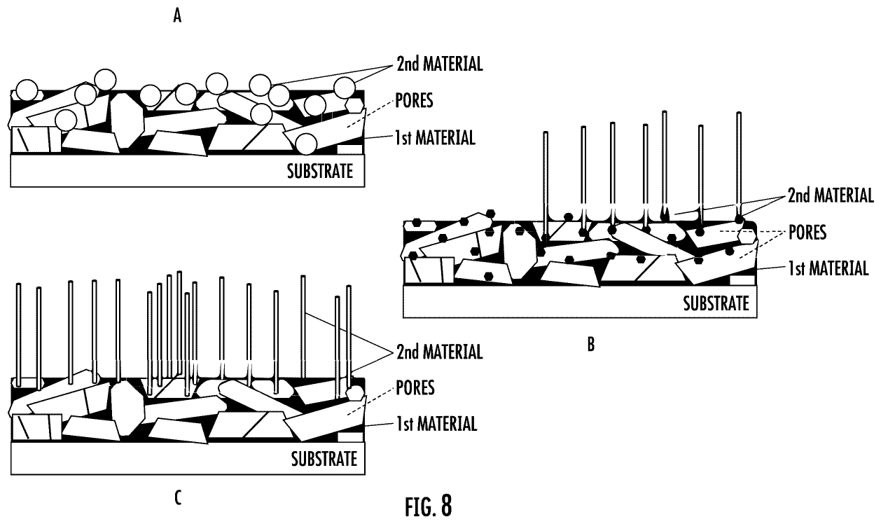

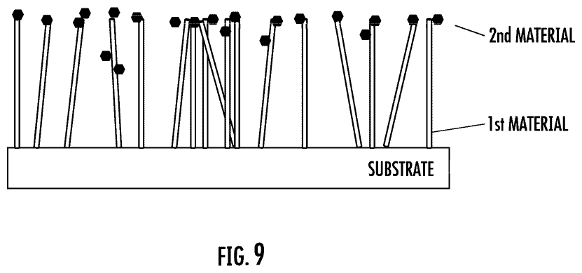

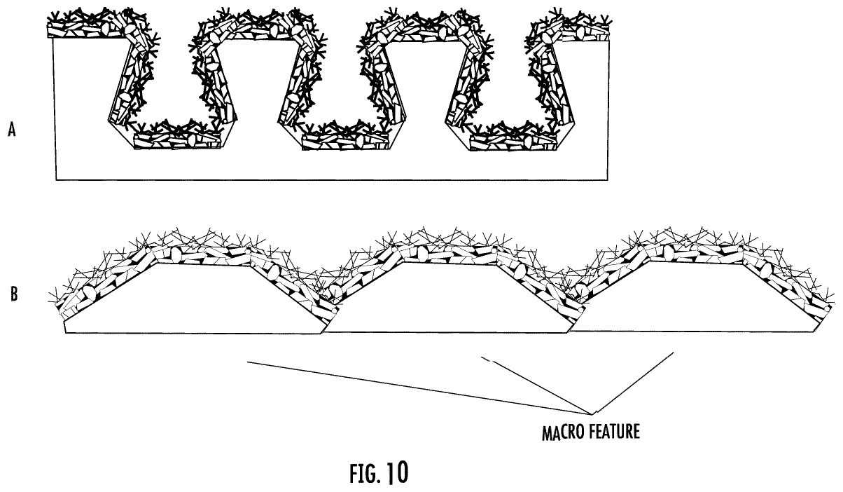

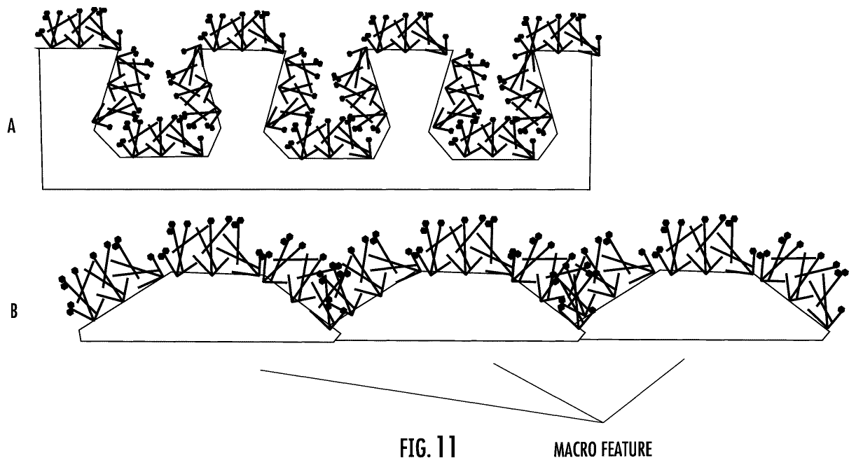

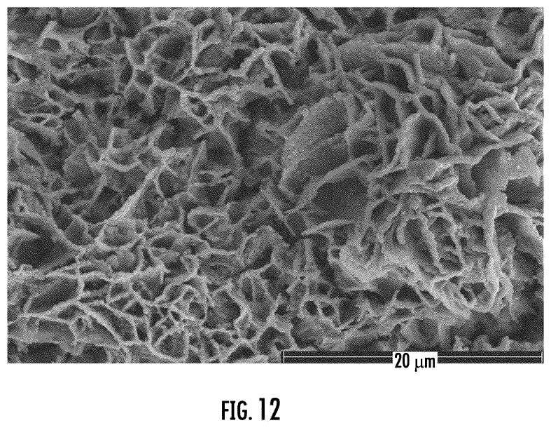

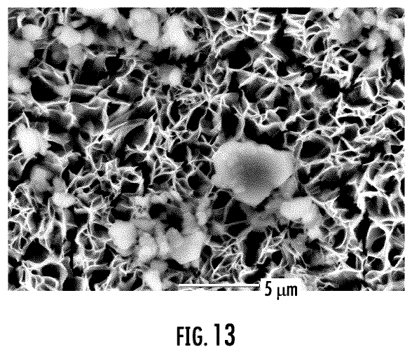

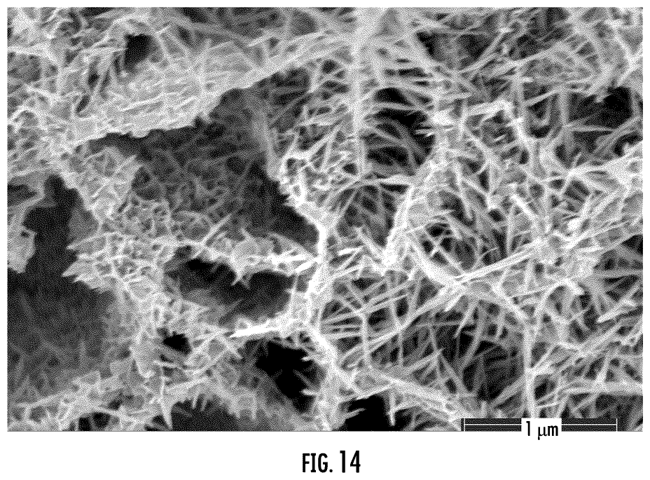

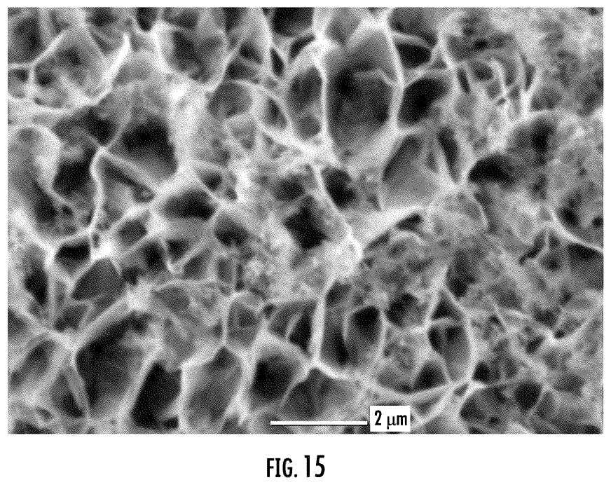

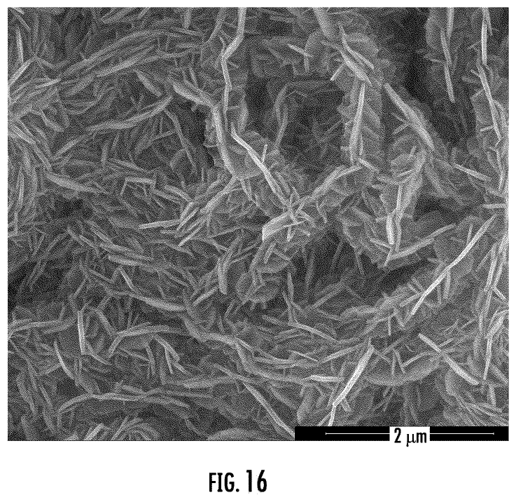

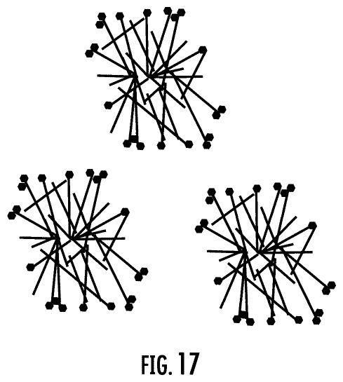

### DETAILED DESCRIPTION

Structural compositions and methods of making the same are provided herein. The structural compositions described herein include geometric features of more than one characteristic length scale (e.g., dimension), such as, but not limited to, thickness, diameter, or pore dimension, that provide a modification of a surface. As nonlimited examples, a first material may be in the form of plates with 20 μm pores, and a second material may be in the form of particles with 5 μm diameter or secondary plates with a 2 μm dimension. A structural composition as disclosed herein includes a substrate, and a coating or surface modification that includes a first material and a second material, wherein the first material includes a porous, nanostructured ceramic (e.g., a nanostructured ceramic material that includes pores) and the second material includes additional structural elements or particles. At least a portion of the substrate is in contact with at least a portion of the first material, and the second material at least partially occupies pores of the first material. Additional treatments, including monolayer and/or polymer coatings, may be applied to the composition that includes the substrate, the first material, and the second material.

The structural compositions described herein are useful for heat exchangers or other components of heating, refrigeration, or air conditioning systems, providing an increased capacity to reduce the impact of ice and frost formation, thereby increasing overall energy efficiency.

The structural compositions described herein are useful for consumer applications such as anodes, cathodes, current collectors and other electronic devices wherein electrical field modulation is impacted by structural designs as described herein; biocompatible surfaces wherein adhesion and tissue growth is enhanced or retarded by structural designs as described herein and may further include inclusion of bioactive compounds and release agents; color, light modulating surfaces and structural dyes wherein the structural designs as described herein modulate or alter the perception of light and color; surface energy modification and tactile surfaces which are impacted by structural designs as described herein; abrasion resistant surfaces which are impacted or improved by preventing the degradation in performance after abrasion by structural designs as described herein.

The structural compositions described herein are useful for industrial applications such as: processing aids wherein surface wettability is impacted by structural designs as described herein; corrosion resistant surfaces wherein local corrosion and surface wettability are impacted by structural designs as described herein; catalytic surfaces wherein catalytic activity is impacted by structural designs as described herein; photocatalytic surfaces wherein photocatalysis rates are impacted by structural designs as described herein and may further include light collecting macrostructures; adhesive surfaces wherein adhesion of additional materials is improved and impacted by structural designs as described herein.

The structural compositions described herein are useful for heat transfer applications such as enhanced phase change materials, thermal collectors and regulators, heat flow modulation, conductors and insulators wherein heat transfer rates and temperatures are impacted by structural designs as described herein.

### Definitions

Numeric ranges provided herein are inclusive of the numbers defining the range.

“A,” “an,” and “the” include plural references unless the context clearly dictates otherwise.

Unless otherwise stated, average values herein refer to number averages.

The phrase “and/or,” as used herein in the specification and in the claims, should be understood to mean “either or both” of the elements so conjoined, i.e., elements that are conjunctively present in some cases and disjunctively present in other cases. Additional elements may optionally be present other than the elements specifically identified by the “and/or” clause, whether related or unrelated to those elements specifically identified, unless clearly indicated to the contrary. Thus, as a non-limiting example, a reference to “A and/or B,” when used in conjunction with open ended language such as “comprising” can refer, in one embodiment, to A without B (optionally including elements other than B); in another embodiment, to B without A (optionally including elements other than A); in yet another embodiment, to both A and B (optionally including other elements); etc.

“Aggregate” refers to an associated collection of individual particles brought together by a rapid agglomeration or coalescence and typically characterized by a low Zeta potential.

“Binder” or binding agent is any material or substance that holds or draws other materials together to form a cohesive whole mechanically, chemically, by adhesion or cohesion.

“Binderless” refers to absence of a binder that may be exogenously added to a primary material to improve structural integrity, particularly with regard to an organic binder or resin (e.g., polymers, glues, adhesives, asphalt) or an inorganic binder (e.g., lime, cement glass, gypsum, etc.).

“Capillary climb” refers to a surface tension driven flow of liquid up a sample (the capillary climb is parallel to, and opposite to, the direction of the force (vector) due to gravity) upon contact with a free surface of liquid.

A “ceramic” or “ceramic material” refers to a solid material including an inorganic compound of a metal or a metalloid, and a non-metal, with ionic or covalent bonds. A “non-metal” may include oxygen (oxide ceramic), or carbon (carbide) or nitrogen (nitride) (non-oxide ceramics). A “metal” may include a non-hydrogen element of Group 1 of the periodic table, an element of Groups 2-12 of the periodic table, or an element from the p-block (Groups 12-17 of the periodic table), e.g., Al, Ga, In, TI, Sn, Pb, Bi, or combinations thereof. A “metalloid” may include B, Si, Ge, As, Sb, Se, Te, or Po, or combinations thereof.

“Contact angle” refers to the angle measured through a liquid from the surface and to the liquid-vapor interface at the contacting surface.

“Contiguous” or “contiguity” refers to pores and structures that contain walls and features in direct contact with one another or that share a common wall across a region or dimension that is large relative to an individual pore or structure.

A “conversion coating” refers to a surface layer in which reactants are chemically reacted with the surface to be treated, which converts the substrate into a different compound. This process is typically not additive or a deposition but may result in a small mass change.

“Engaged’ refers to the degree of overlap of structures when examined in cross section.

“First quartile pore diameter” refers to the value of the pore diameter at which the cumulative pore surface area determined in the direction of increasing pore size is equivalent to 25% of the total cumulative pore surface area as determined by BJH gas adsorption/desorption measurements.

A “functional material layer” refers to a layer of material which may serve as the uppermost surface layer interacting with the surrounding environment or may serve as an interfacial layer for subsequent materials (intermediate layer between two other layers of material). A functional material layer imparts one or more desirable functional properties to the underlying substrate and/or to the material on which it is deposited.

A “gradient” refers herein to a quantitative increase or decrease in one or more physical or chemical property of a material observed by passing spatially from one point to another point along a substrate surface on which the material is situated or immobilized, and varying in an x, y, or z direction in Cartesian coordinates on or through the material. Nonlimiting examples of gradient properties include thickness, density, hardness, ductility, pore size, pore size distribution, pore filling fraction, or chemical or physical composition, including but not limited to, oxidation state, metal concentration, or crosslinking density, for example, resulting in variation in isoelectric point, electrical conductivity, thermal conductivity, capacitance, etc.

“Hierarchical” refers to an arrangement of structures wherein more than one characteristic dimension can be described. In the case of a first nanostructured material (e.g., comprised of nanowalls), the characteristic dimensions are nanowall length, nanowall width and overall layer, e.g., porous layer, thickness. A second material in the form of particles may also have a structure defined by characteristic dimensions that are different, e.g., smaller, than the dimensions of the first material. As an example, the particles may be in the form of hemispherical caps with a characteristic radius. The hierarchical structure that includes the first and second materials would have the cap radius different and likely smaller than the nanowall length. Hierarchical structures may include recursive or fractal geometries.

“Hydrophilic” refers to a surface that has a high affinity for water. Contact angles can be very low (e.g., less than 30 degrees as measured from the surface through the liquid water in the presence of air) and/or immeasurable.

“Layered double hydroxide” refers a class of ionic solids characterized by a layered structure with the generic sequence [AcB Z AcB]n, where c represents layers of metal cations, A and B are layers of hydroxide anions, and Z are layers of other anions and/or neutral molecules (such as water). Layered double hydroxides are also described in PCT Application No. PCT/US2017/052120, which is incorporated by reference herein in its entirety.

A “macro void” refers to a geometric space within solid that has a characteristic dimension substantially larger than the characteristic dimension of an individual pore or feature (e.g., thickness), for example, at least about 5× to about 10× or about 10× to about 100× greater than the characteristic dimension.

“Mean” refers to the arithmetic mean or average.

“Mean pore diameter” is calculated using total surface area and total volume measurements from the Barrett-Joyner-Halenda (BJH) adsorption/desorption method as 4 times the total pore volume divided by the total surface area (4V/A), assuming a cylindrical pore.

A “monolayer” refers to a layer of material that is a single molecule thick. As a nonlimiting example, a single layer coating of a self-organizing treatment of silanes may be attached to a substrate with “feet” attached to or in contact with the substrate surface and “heads” interacting with the environment. In this case, if the molecule were 2 nm in length, the monolayer thickness would be about 2 nm.

“Morphology” or “morphological feature” refers to a general characterization of materials. For example, a rod-shaped unit structure, repeated across a surface, would be considered morphologically different from a plate-like structure, repeated across a surface, and would be considered morphologically different from a crenulated structure. Additionally, a material with nanowalls with a characteristic dimension range of about 1 μm to about 10 μm would be considered morphologically different from a different class of nanowalls with a characteristic dimension range of about 10 to about 100 nm. Recursive or fractal geometries which have similar but different scale features at different scales of investigation also have characteristic morphologies. Example morphologies and characteristic dimensions are provided herein. As one example, a rod-like structure may have a length to diameter ratio of 20:1 L:d rod with an actual dimension that is 20 μm long and a diameter of 1 μm. Another rod-like structure may also have 20:1 L:d aspect ratio with a length of 1 μm long and 0.05 μm in diameter. These examples are morphologically similar and geometrically similar, but have different characteristic dimensions.

“Multimodal” refers to a distribution which contains more than one different mode that appears as more than one distinct peak.

“Nanowalls” refer to plates or platelike structures that when viewed collectively define regions of open space which can be occupied by a gas, a fluid, or a solid, or which may be evacuated and still retain their shape.

“Partially occupies” refers to one particle having a characteristic dimension, at least a part of which fits, engages, or colocates within another particle or voids formed by a series of particles having another characteristic dimension, or within a pore of another material.

“Particles” refers to individual morphologically categorized and defined geometric structures. Particles may be described as having morphologies such as spheres, rods, plates, needles, columns, rosettes, dendrites, stars, sheets, grains, cubes, hemispherical caps, aggregates, films, spheres with colpi, polyhedra, toroidal shapes, stellated shapes, conical sections, crystallographic shapes including cubic, tetragonal, hexagonal, rhombic, monoclinic, and triclinic systems, thin sections or shells of any of the above morphologies, and otherwise ordered materials that can partially occupy at least a portion of the open spaces or pores formed by a material or structure. Particles may refer to elements of a larger structure such as spherical elements that comprise an aggregate, or individual nanowalls that comprise a larger interconnected porous network. Particles may be further described by their characteristic dimensions. For certain particle types, the characteristic dimensions are noted in parentheses below. The particles may have morphologies such as spheres (diameter), rods (length), plates (length), needles (length), columns (length), rosettes (arm length), dendrites (arm length), stars (hydraulic diameter), sheets (thickness), grains (length), cubes (edge length), hemispherical caps (diameter), aggregates (length), films (thickness), spheres with colpi (diameter), polyhedral (volume^{1/3}), toroidal shapes (primary radius), stellated shapes (volume^{1/3}), conical sections (volume^{1/3}), crystallographic shapes (volume^{1/3}) including cubic, tetragonal, hexagonal, rhombic, monoclinic, and triclinic systems, and thin sections or shells of morphologies noted above (same characteristic dimensions).

“Permeability” in fluid mechanics is a measure of the ability of a porous material to allow fluids to pass through it. The permeability of a medium is related to the porosity, but also to the shapes of the pores in the medium and their level of connectedness.

“Pore size distribution” refers to the relative abundance of each pore diameter or range or pore diameters as determined by mercury intrusion porosimetry (MIP) and Washburn's equation.

“Porosity” is a measure of the void (i.e., “empty”) spaces in a material, and is a fraction of the volume of voids, i.e., macro voids, over the total volume, from about 0 to about 1, or as a percentage from about 0% to about 100%. Porosities disclosed herein are measured by mercury intrusion porosimetry.

“Porous” refers to spaces, holes, or voids within a solid material.

“Rolling angle” or “tilting angle” refers to an angle of inclination of a surface at which a droplet begins to roll along the surface under the action of gravity.

A “structure” refers to a geometrically distinct and volumetric formation comprised of smaller particles. Nonlimiting examples include an aggregate of smaller spherical particles, an array of nanowires occupying a larger volume, a series of platelike subunits that form a larger formation, and a collection of particles that form an interconnected network of pores.

“Superhydrophobic” refers to a surface that is extremely difficult to wet. Contact angle is one measure used to determine the degree of wetting and hydrophobicity of a material. Contact angles noted here are measured by a sessile drop method, and quantified by the angle formed from the surface being measured through the liquid droplet on that surface. Superhydrophobic materials refer to a measured sessile drop contact angle >150°. Highly hydrophobic contact angles refer to a measured sessile drop contact angle >120°.

“Surface area per square meter of projected substrate area” refers to the actual measured surface area, usually measured in square meters, divided to the surface area of the substrate if it were atomically smooth (no surface roughness), also typically in square meters.

“Synergy” or “synergistic” refers to the interaction or cooperation between two or more substances, materials, or agents to produce a combined effect that is greater (positive synergy) or lesser (negative synergy) than the sum of their separate, individual effects.

“Thickness” of a material (e.g., the first or second material as described herein) refers to the nominal distance between top and bottom edges or surfaces of a material, such as the surface defined by the edge of the interfacial layer in contact with the substrate or first material in the case of a second material, and the nominal top surface of the layer of surface modification material.

“Third quartile pore diameter” refers to the value of the pore diameter at which the cumulative pore surface area determined in the direction of increasing pore size is equivalent to 75% of the total cumulative pore surface area as determined by BJH gas adsorption/desorption measurements.

“Tortuosity” refers to the fraction of the shortest pathway through a porous structure and the Euclidean distance between the starting and end point of that pathway.

“Tunable” refers to the ability of a function, characteristic, or quality of a material to be changed or modified.

### Structural Compositions

Composite structural compositions disclosed herein include a substrate, a first material, and a second material, wherein the first material includes a porous, nanostructured ceramic and the second material includes additional structural elements or particles. The substrate is in contact with at least a portion of the first material, and the second material occupies at least a portion of pores of the first material, i.e., at least a portion of the second material is within pores of the first material. The first and second materials form a hierarchical surface modification on the substrate. In some embodiments, a hierarchical structure (a first material and a second material that is partially or completely occupies at least a portion of open spaces or pores of the first material) is provided, without an underlying substrate structure. Examples of compositions and morphologies of first materials and second materials, and hierarchical structures that contain the first and second materials, are described herein.

Prior to application of the materials and methods described herein, the substrate may be machined, printed, patterned, or otherwise treated to generate designs and features which are, for example, any of 10⁵, 10⁴, 10³, or 100, to any of 10, 5, 3, or 2 times larger than the characteristic thickness of the first material, e.g., nanostructured layer, described below.

### Substrate

In some embodiments, the substrate is a metal, e.g., comprising aluminum, iron, zinc, manganese, magnesium, copper, nickel, vanadium, and/or silicon. The metal may be an alloy or a pure component material. In some embodiments, the substrate is a ceramic, e.g., comprising aluminum, iron, zinc, silicon, oxygen, and/or carbon. In some embodiments, the substrate is a polymer, e.g., comprising aluminum, silicon, oxygen, nitrogen, phosphorous, sulfur, fluorine, and/or carbon. The polymer may be, for example, in the form of a sheet, an individual fiber, a woven fiber, or a textile fabric.

### First Material

The first material includes characteristic or average dimensions and structural morphology that can be described and measured. The first material has a characteristic chemical composition that can be described, such as a porous, nanostructured ceramic that is well adhered to a substrate.

The generalized first material includes an interconnected porous ceramic surface which has characteristic morphological feature(s). Non-limiting examples of the characteristic geometry (i.e., morphological feature(s)) of the first material include nanowalls, needles, sheets, faceted particles, interconnected geometric particles such as spheres, rods, conical sections, polyhedra, or any other primarily crystalline feature. The particles or geometries may be connected at edges, faces, or ends to form an interconnected ceramic with interconnected pores. The generalized first material is well bound to the substrate surface. The adhesion of the first material to the substrate may include, and optionally be improved by, an interfacial layer (e.g., a layer of material between the substrate and the first material), for example, comprising an oxide, nitride, carbide, or other layer which has a characteristic dimension (e.g., thickness) that is small relative to a characteristic dimension of a geometry (i.e., morphological feature) of the first material. For example, an interfacial layer may include a characteristic dimension (e.g., thickness) such as less than any of about 50%, 30%, 20%, 10%, 5%, 3%, 2%, 1%, 0.5%, 0.3%, 0.2% or 0.1% of the first material nanostructured porous ceramic layer thickness.

A representative first material, established by the methods described herein, is imaged by a scanning electron microscope or other method of observation.

In some embodiments, the morphology of the first material may be characterized as a series of interconnected pores that are distinguished from one another by a feature characterized as a nanowall. The first material has a characteristic thickness, as measured from the substrate interface, or from the surface of an interfacial layer, of about 1 μm to about 5 μm, about 10 μm to about 20 μm, about 5 μm to about 40 μm, about 1 μm to about 100 μm, or about 0.05 μm to about 200 μm. The nanowall features of the first material are characteristically crystalline in nature, with a crystalline plate face characterized by an average critical dimension of about 2 μm, about 1 to about 3 μm, about 0.5 to about 5 μm, or about 0.1 to about 20 μm.

In some embodiments, the morphology of the first material may be characterized as a series of interconnected pores that are distinguished from one another by a feature characterized as nanowalls adjacent to a stellated hemispherical structure. The nanowall features are characteristically crystalline in nature, with a crystalline plate face characterized by an average critical dimension of about 2 μm, about 1 to about 3 μm, about 0.5 to about 5 μm, or about 0.1 to about 20 μm. The stellated hemispherical structures may have an average critical dimension of about 20 μm, or about 15 μm to about 25 μm, about 10 μm to about 40 μm, about 5 μm to about 50 μm, about 1 μm to about 100 μm, or about 0.05 μm to about 200 μm and include a series of nanowalls. The stellated hemispherical structures may also be characterized as floral, floral blooms, or mushroom shaped.

In some embodiments, the first material comprises or consists of a metal oxide, a metal hydroxide, and/or a layered double hydroxide. For example, the metal oxide, a metal hydroxide, and/or a layered double hydroxide may include one or more of magnesium, calcium, zinc, copper, iron, aluminum, manganese, nickel, copper, cobalt, cerium, and silicon. In some embodiments, the metal oxide comprises a transition metal oxide, tin (IV) oxide, magnesium (II) oxide, aluminum oxide, or an earth metal oxide. In some embodiments, the metal oxide comprises zinc oxide, magnesium (II) oxide (MgO), iron (II, III) oxide (Fe₃O₄), iron (III) oxide (Fe₂O₃), manganese (IV) oxide (MnO₂), manganese (II, III) oxide (Mn₃O₄), manganese (III) oxide (Mn₂O₃), nickel (II) oxide (NiO), nickel (III) oxide (Ni₂O₃), chromium (III) oxide (Cr₂O₃), copper (II) oxide (CuO), cobalt (II) oxide (CoO), cobalt (III) oxide (Co₂O₃), and/or cobalt (II, III) oxide (Co₃O₄). In some embodiments, the first material comprises a rare earth metal, Scandium, Yttrium, Lanthanum, Cerium, Praseodymium, Neodymium, Promethium, Samarium, Europium, Gadolinium, Terbium, Dysprosium, Holmium, Erbium, Thulium, Ytterbium, and/or Lutetium.

### Second Material

The second material includes characteristic or average dimensions and structural morphology that can be described and measured. The second material has a characteristic chemical composition that can be described. The second material occupies at least a portion of a void or open space (e.g., pore) defined by the first material, i.e., partially, completely, or substantially completely occupies pores of the first material. The second material is well adhered or otherwise entangled with the first material and optionally entangled with the substrate such as, for example, when the substrate includes macrofeatures.

The adhesion of the second material to the first material may include an interfacial layer (e.g., a layer of material between the substrate and the first material), for example, including an oxide, nitride, carbide, or other layer which has a characteristic dimension (e.g., thickness) that is small relative to a characteristic dimension of a geometry (i.e., morphological feature) of the first material, e.g., nanostructured ceramic, such as less than any of about 50%, 30%, 20%, 10%, 5%, 3%, 2%, 1%, 0.5%, 0.3%, 0.2% or 0.1% of a characteristic dimension of the first material, e.g., nanostructured layer thickness.

The second material may include particles. The particles may have morphologies such as, but not limited to, spheres, rods, plates, needles, columns, rosettes, dendrites, stars, sheets, grains, cubes, hemispherical caps, aggregates, films, spheres with colpi, polyhedra, toroidal shapes, stellated shapes, conical sections, crystallographic shapes including cubic, tetragonal, hexagonal, rhombic, monoclinic, triclinic systems, thin sections or shells of morphologies noted above, or otherwise ordered materials that can partially occupy at least a portion of the void or open spaces (e.g., pores) formed by the first material.

A representative second material, at least partially occupying the void space created by the first material, having a characteristic morphology as described above and produced by the methods described herein, may be imaged by a scanning electron microscope or other method of observation.

In some embodiments, the morphology of the second material may be characterized as hemispherical caps on the surface of and generally in contact with the first material (e.g., nanowalls). The hemispherical caps may have a number average diameter of about 20 nm, about 10 nm to about 30 nm, about 1 nm to about 50 nm, or about 0.5 nm to about 200 nm.

In some embodiments, the morphology of the second material may be characterized as needle-like structures emanating from the surface of and generally in contact with the first material (e.g., nanowalls). The needle-like structures may have a number average length of about 20 nm, or about 10 nm to about 30 nm, about 1 nm to about 50 nm, or about 0.5 nm to about 200 nm, and a length to diameter aspect ratio of about 5, about 2 to about 10, or about 1 to about 100. Rectangular and other non-circular cross section needles may utilize hydraulic diameter in the descriptions above.

In some embodiments, the morphology of the second material may be characterized as a tree-branch geometry attached or adhered to the first material with primary feature sizes of about 1 nm to about 10 nm, about 0.5 nm to about 20 nm, or about 0.2 nm to about 100 nm.

In some embodiments, the morphology of the second material may be characterized in part as fumed silica aggregates of overall length of about 10 μm to about 30 μm, about 5 μm to about 40 μm, or about 1 μm to about 50 μm, or about 0.5 μm to about 100 μm. The aggregates are comprised of several smaller spherical or other shape subunits. The morphology of the second material may also be characterized in part as discrete or disaggregated spheres adhered to the nanowalls with a number average dimension of about 2 μm, about 1 μm to about 3 μm, about 0.5 μm to about 5 μm, or about 0.1 μm to about 20 μm.

In some embodiments, the morphology of the second material may be characterized as spherical agglomerates on the surface of the first material, for example, composed of aluminum hydroxide, for example, adhered to the nanowalls, with an average length of about 1 μm, about 0.5 μm to about 3 μm, about 0.4 to about 5 μm, or about 0.2 μm to about 20 μm. The aggregates may be comprised of several smaller spherical or other shape subunits. The critical dimension of these agglomerates is on average smaller than a critical dimension of the first material, such as thickness.

In some embodiments, the morphology of the second material may be characterized as spherical agglomerates on the surface composed of precipitation reaction products such as insoluble calcium salts of phosphate, carbonate, oxalate, fluoride, or sulfate, for example, with an average diameter of about 1 μm, about 0.5 μm to about 3 μm, about 0.4 μm to about 5 μm, or about 0.2 μm to about 20 μm. The aggregates may be comprised of several smaller spherical or other shape subunits. The critical dimension of these agglomerates is on average smaller than a critical dimension of the first material, such as thickness.

The first and second materials are arranged in such a manner so as to generate a hierarchical structure. These hierarchical structures provide a benefit for the application of interest when used in an environment, such as, but not limited to, water repellency and anti-condensate fouling surfaces. In some embodiments, one such benefit is the prevention of water intrusion into the hierarchical structure and increased liquid mobility along the surface of the first material, the second material, and/or the substrate owing to the hierarchical structure. Both of these attributes are beneficial applications such as heat exchange applications, for example, in near or sub-freezing conditions.

In order to generate a general hierarchical structure of first and second materials as described herein, the second material at least partially occupies a volumetrically defined space provided by the morphology of the first material (e.g., void or open spaces, e.g., pores). Furthermore, both the substrate is in contact with the first material (or with an interfacial layer between the substrate and the first material) and the first material is in contact with the second material (or with an interfacial layer between the first material and the second material). In certain embodiments, a small interfacial layer may form an interface between the first and second materials and/or may form an interface between the substrate and the first material as noted above.

In some embodiments, the second material comprises or consists of a metal oxide, a metal hydroxide, and/or a layered double hydroxide. For example, the metal oxide, a metal hydroxide, and/or a layered double hydroxide may include one or more of magnesium, calcium, zinc, copper, iron, aluminum, manganese, nickel, copper, cobalt, cerium, and silicon. In some embodiments, the metal oxide comprises a transition metal oxide, tin (IV) oxide, magnesium (II) oxide, aluminum oxide, or an earth metal oxide. In some embodiments, the metal oxide comprises zinc oxide, magnesium (II) oxide (MgO), iron (II, III) oxide (Fe₃O₄), iron (III) oxide (Fe₂O₃), manganese (IV) oxide (MnO₂), manganese (II, III) oxide (Mn₃O₄), manganese (III) oxide (Mn₂O₃), nickel (II) oxide (NiO), nickel (III) oxide (Ni₂O₃), chromium (III) oxide (Cr₂O₃), copper (II) oxide (CuO), cobalt (II) oxide (CoO), cobalt (III) oxide (Co₂O₃), and/or cobalt (II, III) oxide (Co₃O₄). In some embodiments, the first second material comprises a rare earth metal, Scandium, Yttrium, Lanthanum, Cerium, Praseodymium, Neodymium, Promethium, Samarium, Europium, Gadolinium, Terbium, Dysprosium, Holmium, Erbium, Thulium, Ytterbium, and/or Lutetium.

In some embodiments, the second material comprises or consists of glass, or naturally occurring inorganic materials that have been refined or separated by size, or other amorphous ceramic materials.

In some embodiments, the second material comprises or consists of precipitation reaction products, minerals, or other insoluble salts.

In some embodiments, the second material comprises or consists of one or more polymers.

### Hierarchical Structures

The first and second materials as described herein form a hierarchical structure, optionally on the surface of a substrate. In some embodiments, the first and second materials have the same or similar chemical compositions, but may be described by different physical morphologies. In other embodiments, the first and second materials have different chemical compositions, and same or similar, or different, physical morphologies. For example, in a non-limiting embodiment, the first material may be in the form of a porous layer (e.g., first material is metal oxide (e.g., MnOx) plates forming a porous layer), and the second material may be of the same or similar chemical composition as the first material but may be in a different morphological form, such as needle-like structures (e.g., second material is the same or similar metal oxide (e.g., MnOx) needles).

The first and second materials may have different chemical compositions, but may be described by similar physical morphology. For example, in a non-limiting embodiment, the first material may be in the form of a porous layer (e.g., first material is metal oxide (e.g., ZnOx) plates forming a porous layer), and the second material may be smaller plates of a different chemical composition than the first material (e.g., smaller plates of a different metal oxide (e.g., MgOx)).

The first and second materials may have different chemical compositions and may be described by different physical morphologies. For example, in a non-limiting embodiment, the first material may be in the form of a porous layer (e.g., first material is metal oxide (e.g., ZnOx) plates forming a porous layer), and the second material may be a different morphological form and chemical composition than the first material (e.g., a different metal oxide (e.g., AlOx) aggregates).

In some embodiments, the interface between the first and second materials includes an interfacial layer with a gradient interfacial composition or morphology. The interfacial layers or transitional layers may have a characteristic dimension that is small, such as less than any of about 50%, 30%, 20%, 10%, 5%, 3%, 2%, 1%, 0.5%, 0.3%, 0.2% or 0.1% of a characteristic dimension of the first material, such as thickness of the first material, e.g., thickness of a nanostructured layer.

Hierarchical structures may comprise one material with two different size scales, or two or more materials (different chemical compositions) with different size scales. In some embodiments, the hierarchical structure includes at least one first material (e.g., structure) which can be characterized by having a dimensional scale (e.g., characteristic dimension) ranging from about 10 nm to about 100 μm and a distribution density (frequency or pitch of features) approximately 5-10 times larger than the characteristic dimension. In some embodiments, the hierarchical structure includes at least one second material (e.g., structure) which may be characterized by a dimensional scale approximately 5-100× smaller than the first material, ranging from about 1 nm to about 10 μm, and a distribution density approximately 1-100 times larger than the characteristic dimension. Further, the first and second materials (e.g., structures) may be engaged and/or may have an occupancy (degree of physical overlap) ranging from 1-100% when viewed in a planar cross-sectional context. For example, in a nonlimiting example, in a structure have a pore of 100 μm and particle of 10 μm, the particle may be fully inside the pore (100% occupancy, halfway in the pore 50% occupancy, or only a very little inside the pore (˜1% occupancy).

The ratio of the critical dimensions of the first and second materials may be about 1 to about 2, about 1 to about 3, about 1 to about 4, about 1 to about 5, about 1 to about 10, about 1 to about 20, about 1 to about 50, about 1 to about 100, about 1 to about 1000 or about 1 to about 10,000 (second material dimension: first material dimension).

In one aspect, composite materials are provided that comprise a hierarchical structure. In certain embodiments, the composite materials include a first material that comprises or consists of a nanoporous ceramic, and a second material that comprises ceramic particles or materials. In some embodiments, the composite material comprises a first material that is well adhered to a substrate or to an interfacial layer between the substrate and the first material, and provides void spaces (e.g., pores) which may be partially or completely occupied by a second material.

In certain embodiments, the hierarchical structure includes a first material that comprises or consists of a nanoporous ceramic, and a second material that comprises ceramic particles or materials. In some embodiments, the hierarchical structure that comprises a first and second material is not well adhered to a substrate, and the second material at least partially occupies at least a portion of void spaces (e.g., pores) defined by the first material. For example, this composite material may be a loose particulate that can be suspended in an agitated fluid. The composite material may be electrostatically, gravitationally, or otherwise adhered to the substrate, but may be readily removed with a light wiping or spraying of a working fluid prior to a subsequent thermal curing operation.

In some embodiments, the first material may be a surface modification material that is in contact with a surface of a substrate. In some embodiments, the first material and the second material are configured in an interconnected layered manner wherein the second material at least partially occupies the void spaces (e.g., pores) of the first material. In some embodiments, the composite material may include a plurality of layers or structures.

In some embodiments, a hierarchical structure as described herein is not attached or adhered to a substate. In certain nonlimiting embodiments, the first material may be ceramic particles that are not connected to a substrate and that have characteristic morphological feature(s). Nonlimiting examples of the characteristic geometry (i.e., morphological feature(s)) of the first material include nanowalls, needles, sheets, faceted particles, interconnected geometric particles such as spheres, rods, conical sections, polyhedra, or any other primarily crystalline feature. The geometries (features) may be connected at edges, faces, or ends to form an interconnected ceramic with interconnected pores. In some embodiments the second material at least partially occupies the void spaces (pores) within the first material that are defined by the first material's geometry. The second material has characteristic morphological feature(s) with average dimensions and structural morphology that can be described and measured.

In some embodiments, the composite material or hierarchical structure may optionally be coated or otherwise treated by the subsequent addition of a functional layer or top coat.

In some embodiments, the functional layer or top coat material comprises or consists of a molecule with a polar head group and a non-polar tail group. For example, the molecule with a polar head group and a non-polar tail group may comprise or consist of one or more of a fatty acid, a salt of a fatty acid, a triglyceride, a phospholipid, and cholesterol. In some embodiments, the head group includes a silane group, a sulfonate group, a sulfonic acid group, a boronate group, a boronic acid group, a phosphonate group, a phosphonic acid group, a carboxylic acid group, a vinyl group, an alcohol group, a hydroxide group, a thiolate group, a thiol group, and/or an ammonium group (e.g., a quaternary ammonium group), and the tail group includes a hydrocarbon group, a fluorocarbon group, a vinyl group, a phenyl group, an epoxide group, an acrylic group, an acrylate group, a hydroxyl group, a carboxylic acid group, a thiol group, and/or a quaternary ammonium group.

In some embodiments, the hydrophobic compound with a polar head group and a non-polar tail group comprises an alkyl group, a methyl group, a fluoroalkyl group, a perfluoroalkyl group, a vinyl group, a phenyl group, a substituted alkyl group, or an aryl group.

In some embodiments, the functional layer or top coat material comprises or consists of an organosilane molecule.

In some embodiments, the functional layer or top coat material comprises or consists of a biopolymer, such as polynucleotide, polypeptide, or polysaccharide, or a polynucleotide, polypeptide, or polysaccharide containing material, or a natural rubber or polymer such as isoprene, lignin, sebum, melanin, or a mixed organic/inorganic material such as nacre.

In some embodiments, the first material has a thickness of about 50 nm to about 200 μm. In some embodiments, the ratio of thickness of a functional layer or top coat material to the first material characteristic thickness is less than any of about 50%, 30%, 20%, 10%, 5%, 3%, 2%, 1%, 0.5%, 0.3%, 0.2% or 0.1%.

In some embodiments, the first material includes a porosity greater than any of about 75%, 50%, 40%, 35%, 30%, 25%, 20%, 15%, or 10%. In some embodiments, the first material comprises or consists of a nanostructured material, e.g., a porous nanostructured material.

### Articles of Manufacture

Articles of manufacture are provided, which comprise or consist of any of the composite materials described herein, i.e., a composite material that includes a substrate and a hierarchical structure thereon that includes a first material and a second material, as described herein, optionally with a interfacial layer between the substrate and the first material and/or between the first material and the second material. In some embodiments, the article of manufacture is a heat exchanger. In some embodiments, the article of manufacture is a surface comprising a larger article, such as an architectural product such as a building, façade, roof, window, or screen, a transportation unit such as an automobile, truck, aircraft, or ship. In some embodiments, the article of manufacture is a manufacturing unit for additional goods such as a roll of material from which heat exchanger fins are produced, barrier screens are generated, or consumer items are manufactured.

### Methods

Methods are provided for producing composite materials as described herein, i.e., a composite material that includes a substrate and a hierarchical structure thereon that includes a first material and a second material, as described herein, optionally with a interfacial layer between the substrate and the first material and/or between the first material and the second material.

In one embodiment, the method includes: (a) contacting at least a portion of a surface of a substrate with an aqueous solution that comprises a metal salt and an amine, thereby depositing a first material on the at least a portion of the surface of the substrate, wherein the first material comprises void space (e.g., pores); (b) contacting at least a portion of the surface of the first material with an aqueous solution that comprises a metal salt and an amine, thereby depositing a second material on the at least a portion of the first material wherein at least a portion of the second material occupies at least a portion of the void space within the first material, and thereby producing a hierarchical composite material; and optionally, (c) drying said composite material. In some embodiments, the first material and the second material are porous ceramic materials, for example, a metal oxide, metal oxide, and/or layered double hydroxide material, e.g., nanoporous ceramic materials. In some embodiments, the first material is a porous ceramic material, for example, a metal oxide, metal oxide, and/or layered double hydroxide material, e.g., nanoporous ceramic material, and the second material is a thin film ceramic.

In another embodiment, the method includes: (a) contacting at least a portion of a surface of a substrate with an aqueous solution that comprises a metal salt and an amine, thereby depositing a first material on the at least a portion of the surface of the substrate, wherein the first material comprises void space (e.g., pores); (b) contacting at least a portion of the surface of the first material with the aqueous solution of (a) or with an aqueous solution that comprises a metal salt and an amine, wherein the metal salt is different than the metal salt in (a), under modified conditions, such as modified temperature, pressure, and/or agitation conditions, thereby depositing a second material on the at least a portion of the first material wherein at least a portion of the second material occupies at least a portion of the void space within the first material, and thereby producing a hierarchical composite material; and optionally, (c) drying said composite material. In some embodiments, the first material and the second material are porous ceramic materials, for example, a metal oxide, metal oxide, and/or layered double hydroxide material, e.g., nanoporous ceramic materials. The modified conditions result in different structural morphologies for the first and second materials.

In another embodiment, the method includes: (a) contacting at least a portion of a surface of a substrate with an aqueous solution that comprises a metal salt and an amine, thereby depositing a first material on the at least a portion of the surface of the substrate, wherein the first material comprises void space (e.g., pores), and optionally, drying or calcining the deposited first material in air; (b) contacting at least a portion of the surface of the dried or calcined first material with the aqueous solution of (a) or with an aqueous solution that comprises a metal salt and an amine, wherein the metal salt is different than the metal salt in (a). under modified conditions, such as modified temperature, pressure, and/or agitation conditions, thereby depositing a second material on the at least a portion of the dried or calcined first material wherein at least a portion of the second material occupies at least a portion of the void space within the first material, and thereby producing a hierarchical composite material; and optionally, (c) drying said composite material. In some embodiments, the first material and the second material are porous ceramic materials, for example, a metal oxide, metal oxide, and/or layered double hydroxide material, e.g., nanoporous ceramic materials. The modified conditions result in different structural morphologies for the first and second materials.

In another embodiment, the method includes: (a) contacting at least a portion of a surface of a substrate with an aqueous solution that comprises a metal salt and an amine, thereby depositing a first material on the at least a portion of the surface of the substrate, wherein the first material comprises void space (e.g., pores); (b) contacting at least a portion of the surface of the first material with an aqueous solution comprising a buffer, optionally comprising a metal salt and a buffer, thereby depositing a second material which occupies at least a portion of the void space within the first material, and thereby producing a hierarchical composite material; and optionally, (c) drying said composite material. The buffer maintains a pH condition, such as high or low pH, and the second material is a different chemical composition than the first material. In some embodiments, step (b) is a conversion step, and the second material is produced from the first material.

In another embodiment, the method includes: (a) contacting at least a portion of a surface of a substrate with an aqueous solution that comprises a metal salt and an amine, thereby depositing a first material on the at least a portion of the surface of the substrate, wherein the first material comprises void space (e.g., pores), and optionally, drying or calcining the deposited first material in air; (b) contacting at least a portion of the surface of the dried or calcined first material with an aqueous solution comprising a metal salt and a buffer, thereby depositing a second material which occupies the void space within the first material, and thereby producing the hierarchical composite material; and optionally, (c) drying said composite material.

In another embodiment, the method includes: (a) contacting at least a portion of a surface of a substrate with an aqueous solution that comprises a metal salt and an amine, thereby depositing a first material on the at least a portion of the surface of the substrate, wherein the first material comprises void space (e.g., pores); (b) contacting at least a portion of the surface of the first material with a particulate containing aqueous solution, thereby depositing a second material, wherein at least a portion of the second material occupies the void space generated by the first material, and thereby producing the hierarchical composite material; and optionally, (c) drying said composite material. In some embodiments, the particulate containing solution contains an insoluble particulate, such as, but not limited to, silica or calcium carbonate.

In another embodiments, the method includes: (a) dipping a cleaned substrate into an aqueous bath containing at least one metal salt and an amine, thereby producing a coated substrate comprising a first material deposited on the substrate, wherein the first material is a ceramic crystal structure, (b) placing the coated substrate in contact with a first precipitation reaction reagent to distribute the reagent throughout at least a portion of the first material, for example at temperatures from about 20° C. to about 90° C., and then placing the coated substrate in contact with a second precipitation reaction reagent at temperatures from about 20° C. to about 90° C., thereby depositing a second material, wherein at least a portion of the second material occupies void spaces within the crystal structure; optionally, (c) removing the coated substrate from the precipitation reagent containing solutions, and drying it to remove water or solvent from the substrate and ceramic surface, and optionally, (d) making the coated substrate hydrophobic by coating the coated substrate with a hydrophobic compound. Some embodiments may include multiple iterations of step (b) or multiple iterations of steps (b) and (c) prior to subsequent processing steps such as step (d). In some embodiments, particulates are generated which form a precipitate salt. For example, calcium may be precipitated with sulfate to produce calcium sulfate (gypsum) particles.

In some embodiments, the substrates are prepared for further processing, i.e., prior to deposition of first and second materials, by a solvent or waterborne cleaning. In some embodiments, the substrates are prepared for further processing by an alkaline, or acid surface treatment. In some embodiments, the substrates are prepared for further processing by thermal or plasma treatments. In some embodiments, substrates are prepared for further processing by combinations of the options noted above.

In some embodiments, substrates with a first material are dried prior to subsequent processing because it is advantageous for the first material or second material addition or subsequent steps. “Drying” herein may denote removal of mass (e.g., water), such as removal of at least about 80% or at least about 90% of mass that would be removed if held at those conditions until equilibrium. For example, at 40° C., this might be a low amount of mass loss to reach equilibrium with the local humidity, at 110° C., this would be almost all the water and some light materials, and at 400° C., it might include intercalated species and compositional changes that occur (liberating CO₂ for example). In some embodiments, substrates with a first material and a second material are dried prior to subsequent processing because it is advantageous for the second material or subsequent processing. In some embodiments, materials are dried between each processing step. In some embodiments, substrates with a first material are calcined prior to subsequent processing because it is advantageous for the first material or second material or subsequent steps. In some embodiments, substrates with a first material and a second material are dried prior to subsequent processing because it is advantageous for the second material or subsequent processing. Advantages of drying or calcining include, but are not limited to, logistic advantages for ease of processing, ease of deposition of the second material on the first material, change in composition or structural/morphological properties of the first or second material, avoiding contamination to materials used in subsequent processing steps, and/or change in stability (making the material more or less stable, depending on the composition).

In some embodiments of the methods described herein, the amine, e.g., in a solution that contains a metal salt and an amine, may comprise or consist of hexamine. In some embodiments, the amine may comprise or consist of one or any combination of two or more of hexamine, urea, ammonia, ethylenediamine tetraacetatic acid (EDTA), monoethanolamine (MEA), 2-ethanolamine, amino acids, casein, corrosion inhibitors, and quaternary ammonium compounds. Amine containing compounds which have a kinetic decomposition time consistent with the deposition time and temperature may be used, for example, such that about 0.1% to about 1%, about 1% to about 5%, about 5% to about 20%, or about 20% to about 50% of the initial concentration is decomposed during the processing period.

In some embodiments, a method as described herein further includes: (d) contacting (e.g., spraying, immersing, dipping, drop coat, fogging, doctor blade, gravure, etc.) the composite material (i.e., substrate, first material, and/or second material) with a solution that includes a polymer or monomer (e.g., silane, functional coating, paint), or fatty acid or a salt thereof, to provide additional functional benefit. For example, the solution that includes the polymer, monomer, fatty acid or salt thereof may have a concentration of about 0.1% (w/w) to about 10% (w/w) of the polymer, monomer, fatty acid or salt thereof in alcohol or water at a temperature that is greater than about 20° C.

In some embodiments, the method further includes: (d) contacting (e.g., spraying, immersing, dipping, drop coat, fogging, doctor blade, gravure, etc.) the composite material (i.e., substrate, first material, and/or second material) with a solution that includes an organic silane, an acid, and a solvent, to provide additional functional benefit. For example, the solution that includes the organic silane, acid, and solvent contains less than about 10% (w/w) water and the organic silane has a concentration of about 0.01% (w/w) to about 0.1% (w/w), about 0.1% (w/w) to about 1% (w/w), about 1% (w/w) to about 10% (w/w) of the organic silane in a solvent comprising, for example, ethanol, methanol, butanol, or ethyl acetate, formaldehyde, d-limonene, toluene, acetone, 2-propanol (isopropyl alcohol), hexanal, C5-C20 Petroleum hydrocarbons, HCFC-225ca, HCFC-225cb, HCFO-1233 yd (Z), HFC-245fa, HFC-365mfc, HFE-347mcc3 (heptafluoropropyl methyl ether), HFE-347pcf2, HFE-449s1 (methoxynonafluorobutane, iso and normal), HFE-569sf2 (ethoxynonafluorobutane, iso and normal), HFO-1336mzz (Z), Methoxytridecafluoroheptene isomers (MPHE), Oxygenated organic solvents (esters, ethers, alcohols, ketones), Terpenes, Trans-1,2-dichloroethylene, or Trans-1-chloro-3,3,3-trifluoroprop-1-ene, or water-based formulations, for example, at a temperature that is greater than about 20° C.

In some embodiments, the method further includes: (d) contacting (e.g., spraying, immersing, dipping, drop coat, fogging, doctor blade, gravure, etc.) the composite material (i.e., substrate, first material, and/or second material) with a solution that includes an organic silane, such as an organic silane as described above, an acid, water, and a surfactant to maintain the organic silane in solution, to provide additional functional benefit. For example, the solution that includes the organic silane, acid, and surfactant contains more than about 50% (w/w) water and the organic silane has a concentration of about 0.01% (w/w) to about 0.1% (w/w), about 0.1% (w/w) to about 1% (w/w), about 1% (w/w) to about 10% (w/w) of the organic silane in an aqueous suspension, for example, at a temperature that is greater than about 20° C.

In some embodiments, the method further includes: (d) contacting (e.g., spraying, immersing, dipping, drop coat, fogging, doctor blade, gravure, etc.) the composite material (i.e., substrate, first material, and/or second material) with a solution that includes a solvent, an acid catalyst, and a specialty chemical or specialty chemical precursor to provide additional functional benefit. For example, the solution that includes the solvent, an acid catalyst and specialty chemical or specialty chemical precursor thereof may contain concentration of about 0.01% (w/w) to about 20% (w/w) of the specialty chemical or specialty chemical precursor thereof in alcohol or water at a temperature, for example, that is about 10° C. to about 50° C. For example, this may include immersion of the substrate, the first material, and the second material in an azeotropic ethanol/water bath containing a few drops of hexadecyltriethoxysilane and an acid catalyst, for example, for about 30 seconds to about 24 hours. For example, this may include immersion of the substrate, the first material, and the second material in an aqueous solution containing a few drops of octyltriethoxysilane, a surfactant, and an acid catalyst, for example, for about 30 seconds to about 24 hours.

In some embodiments, forming the substrate, prior to preparation of the substrate surface and step (a) (depositing of the first material) includes casting, molding, extruding, rolling, 3D printing, or otherwise machining materials to form a patterned substrate with features typically larger than the characteristic dimension of the first material and may be either uniform and repeatable across the substrate or unique and non-repetitive across the substrate.

In some embodiments, the substrate is lithographically, optically, electron or ion beam patterned prior to processing such that processing steps reveal a repeating pattern on the substrate which may have a characteristic length larger or smaller than that of the first material characteristic dimension.

In some embodiments, preparation of the substrate surface, prior to depositing the first material, includes: immersing or spraying the substrate with an aqueous solution that removes loosely adhered debris, or carbonaceous residue; immersing or spraying the substrate with an aqueous solution that etches or otherwise solubilizes at least a portion of the substrate material; immersing or spraying the substrate with an aqueous solution that oxidizes at least a portion of the substrate material; immersing or spraying the substrate with an aqueous solution that chemically converts at least a portion of the substrate material to a different composition (e.g., a conversion coating).

In some embodiments, step (a) (depositing the first material on the substrate) includes spraying the substrate with or immersing the substrate in the aqueous solution, at a temperature of about 20° C. to about 90° C. for a duration of about 30 seconds to about 2 hours. For example, the aqueous solution may include about 10 mM to about 500 mM of the metal salt and about 10 mM to about 500 mM of the amine to generate the first material.

In some embodiments, step (a) (depositing the first material on the substrate) includes a periodic agitation of the substrate relative to the aqueous solution, relative movement of the aqueous solution across the substrate, or other non-steady aqueous solution dynamics. For example, this may provide coating uniformity and/or deposition rate improvement.

In some embodiments, the method further includes drying and stabilizing or otherwise oxidizing the first material after step (a) (depositing the first material on the substrate) and prior to step (b) (formation and depositing of the second material).

In some embodiments, step (b) (formation and depositing of the second material) includes contacting (e.g., spraying, immersing, dipping, drop coat, fogging, doctor blade, gravure, etc.) the substrate and the first material with aqueous solution, for example, at a temperature of about 20° C. to about 90° C. and for example, for a duration of about 30 seconds to about 2 hours. For example, the aqueous solution may include about 10 mM to about 250 mM of a metal salt and about 10 mM to about 250 mM of an amine to generate the second material wherein at least a portion of the second material partially occupies void space of the first material. The relative velocity of the liquid solution adjacent to the surface and the substrate with first material can be modified from near quiescent conditions to laminar flow to turbulent flow to modulate the morphology of the second material. The substrate composition (e.g., alloy) and processing conditions that are used in production of the first material can be used to modulate the morphology of the second material when stellated structures are produced.

In some embodiments, step (b) (formation and depositing of the second material) includes contacting (e.g., spraying, immersing, dipping, drop coat, fogging, doctor blade, gravure, etc.) the substrate and the first material with a solution, for example, at a temperature of about 20° C. to about 90° C. and for example, for a duration of about 30 seconds to about 2 hours. For example, the solution may include a variety of monomers and polymer oligomers of about 10 g/L to about 200 g/L and a cross-linker at concentrations ranging from about 2 g/L to about 50 g/L to generate the second material, wherein at least a portion of the second material partially occupies void space of the first material. The solution may be pH adjusted to modify the resulting second material structure. The primary structures are mixed metal oxide nanowalls with an average critical dimension of 2 μm. Secondary structures are a tree-branch geometry with primary feature sizes ranging from about 0.02 μm to about 20 μm.

In some embodiments, step (b) (formation and depositing of the second material includes contacting (e.g., spraying, immersing, dipping, drop coat, fogging, doctor blade, gravure, etc.) the substrate and the first material with a solution, for example, at a temperature of about 20° C. to about 90° C. and for example, for a duration of about 30 seconds to about 2 hours. For example, the solution comprises a dispersion of hydrophilic fumed silica that is created by dispersing the silica particles in ethanol or water at concentrations of about 0.1 wt % to about 10 wt % and mixing in a high shear mixer for about 5 minutes to about 30 minutes to break up the aggregates. Upon contact with the solution, fumed silica aggregates are deposited wherein at least a portion of the second material partially occupies the void space of the first material.

In some embodiments, step (b) (formation and depositing of the second material) includes contacting (e.g., spraying, immersing, dipping, drop coat, fogging, doctor blade, gravure, etc.) the substrate and the first material with a solution, for example, at a temperature of about 20° C. to about 100° C. and for example, for a duration of about 5 seconds to about 2 hours. For example, the solution comprises a dispersion of aluminum hydroxide in an acidified ethanol solution at concentrations of about 0.05 wt % to about 10 wt %. Upon contact with the solution, spherical agglomerates are formed on the surface of the first material and composed of aluminum hydroxide.

In some embodiments, step (b) (formation and depositing of the second material) includes contacting (e.g., spraying, immersing, dipping, drop coat, fogging, doctor blade, gravure, etc.) the substrate and the first material with an aqueous solution, for example, at a temperature of about 30° C. to about 99° C. and for example, for a duration of about 5 minutes to about 2 hours. For example, the solution may include metal salts featuring corrosion resistant metals such as zinc, manganese, copper, lithium and/or silver or highly soluble metal cations such as sodium and/or potassium and anionic components including carbonates, bicarbonates, phosphates, nitrates, chlorates, tungstates, vanadates, molybdates and/or sulfates for at least a partial conversion of the first material, and thereby creating a second material which at least partially occupies void space of the first material.

In some embodiments, step (b) (formation and depositing of the second material) includes contacting (e.g., spraying, immersing, dipping, drop coat, fogging, doctor blade, gravure, etc.) the substrate and the first material with a precipitation reactant containing aqueous solution, for example, at a temperature of about 20° C. to about 99° C. and for example, for a duration of about 30 seconds to about 2 hours, then contacting the substrate and first material with, contacting the first material with, contacting the substrate and first material with, or immersing the substrate and first material in a complementary precipitation reactant containing aqueous solution, for example, at a temperature of about 20° C. to about 99° C. and, for example, for a duration of about 30 seconds to about 2 hours. For example, the solution may include metal containing salts and complementary precipitation reaction reactants including phosphates, carbonates, oxalates, fluorides, or sulfates for at least a partial reaction of the reagents to form a precipitation product thereby creating a second material which at least partially occupies void space of the first material. The second material may be in the form of spherical particulates or aggregates. In some embodiments, this procedure is repeated for several cycles prior to subsequent process steps.

In some embodiments, step (b) (formation and depositing of the second material) includes a periodic agitation of the substrate and the first material relative to the aqueous solution, relative movement of the aqueous solution across the substrate and the first material, or other non-steady aqueous solution dynamics relative to the substrate and first material. This may provide uniformity and rate improvement.

In some embodiments, step (b) (depositing of the second material) includes a dry addition of particles to the substrate and the first material, an electrostatic addition of particles to the substrate and first material, or other procedure for transporting particles to the substrate and the first material, wherein the particles at least partially occupy void space within the first material.

In some embodiments, step (b) (depositing of the second material) includes a vapor phase deposition of a second material to the substrate and the first material wherein the second material at least partially occupies void space within the first material.

In some embodiments, deposition of the first and second materials do not include an externally applied electrical current or voltage through aqueous process liquids (e.g., aqueous solution of metal salt and amine or buffer).

In some embodiments, the method further includes drying and stabilizing or otherwise oxidizing the second material after depositing of the second material, and optionally prior to subsequent processing step(s) such as, but not limited to, coating with a hydrophobic compound or any other additional processing steps described herein.

In some embodiments, drying the substrate, the first material, and the second material is performed at a temperature of about 30° C. to about 600° C., for a duration of about 5 minutes to about 2 hours in air or a controlled atmosphere comprising carbon dioxide, nitrogen, argon, or other gas mixtures at about 0.1 bar to about 3 bar pressure.

In some embodiments, an optional step (e) which comprises drying or curing may follow step (d) (e.g., coating of the composite structure with a hydrophobic compound. The conditions of step (e) may include a temperature from about 40° C. to about 275° C. and time frame about 1 minute to about 120 minutes in air or a controlled atmosphere comprising carbon dioxide, nitrogen, argon, or other gas mixtures at about 0.1 bar to about 3 bar pressure. For example, this step (e) may comprise a temperature of about 90° C. to about 120° C. in air at 1 bar for about 30 to about 90 minutes.

In some embodiments, methods for contacting substrate, first materials, and second material with different solutions include different times of immersion. These times are intended to represent a time required to reach a relative steady condition free from initial substrate-liquid interaction and may be about 30 seconds, may be about 20 seconds to about 30 seconds, about 10 seconds to about 30 seconds, about 5 seconds to about 30 seconds or about 1 second to 30 seconds, depending on the conditions of the substrate-liquid interactions.

In some embodiments, methods include a time frame for drying or calcining substrates, first and second materials, e.g., time frame for removal of at least about 80% or 90% of mass. These times are intended to represent a time required to substantially remove moisture and volatile materials, or about 80% of the moisture and volatile material removed at those drying conditions, and/or to represent a time required to substantially convert or calcine greater than about 50% of the conversion. These times may be about 5 minutes, or about 3 minutes to about 5 minutes, or about 2 minutes to about 5 minutes, or about 1 minute to 5 minutes, or shorter depending on the thermal mass and binding energy of the materials to be removed or converted.

In some embodiments, the composite material prepared according to methods described herein with the inclusion of addition of a hydrophobic material and optionally, a drying or curing step, result in the formation of a hydrophobic surface, as determined by a sessile drop contact angle measurement greater than about 90°, or about 90° to about 120°, or about 90° to about 150°, or about 90° to about 179°, or greater than about 150°, or about 150° to about 160°, or about 150° to about 170°, or about 150° to about 179°. Materials with sessile contact angle measured greater than about 150° are considered superhydrophobic.

In some embodiments, the composite material prepared according to methods described herein without the inclusion addition of a hydrophobic material result in the formation of a hydrophilic surface, as determined by a sessile drop contact angle measurement less than about 90°, or about 30° to about 90°, or about 15° to about 90°, or about 10° to about 90°, or about 5° to about 90°, or at an unmeasurable level below about 5°. Materials with sessile contact angle measured less than about 5° are considered to be completely wetting.

In some embodiments, the composite material prepared according to methods described herein with the inclusion of addition of a hydrophobic material and optionally, a drying or curing step result in the formation of a hydrophobic surface, as determined by the rolling angle of a less than about 90° when measured as the angle of a substrate and the flat surface orthogonal to the normal gravitational vector at which a droplet at rest begins to move under gravitational force, or about 30° to about 90°, or about 15° to about 90°, or about 10° to about 90°, or about 5° to about 90°, or about 2° to about 90°, or about 1° to about 90° or about 0.1° to about 90°, or about 0.02° to about 90°.

In some embodiments, the composite material prepared according to methods described herein including addition of a hydrophobic material and optionally, a drying or curing step results in the formation of a hydrophobic surface. In some embodiments the hydrophobic surface is characterized by a rolling angle of less than about 90°. In some embodiments the rolling angle is the angle of a substrate relative to a flat surface orthogonal to the normal gravitational vector at which a droplet at rest on the substrate begins to move solely under gravitational force. In some embodiments the hydrophobic surface is characterized by a rolling angle of about 30° to about 90°. In some embodiments the hydrophobic surface is characterized by a rolling angle of about 15° to about 90°. In some embodiments the hydrophobic surface is characterized by a rolling angle of about 10° to about 90°. In some embodiments the hydrophobic surface is characterized by a rolling angle of about 5° to about 90°. In some embodiments the hydrophobic surface is characterized by a rolling angle of about 2° and about 90°. In some embodiments the hydrophobic surface is characterized by a rolling angle of about 1° to about 90°. In some embodiments the hydrophobic surface is characterized by a rolling angle of about 0.1° and about 90°. In some embodiments the hydrophobic surface is characterized by a rolling angle of about 0.02° to about 90°. In some embodiments the hydrophobic surface is characterized by a rolling angle of about 0.1° to about 5°. In some embodiments the hydrophobic surface is characterized by a rolling angle of about 1° to about 10°. In some embodiments the hydrophobic surface is characterized by a rolling angle of about 2° to about 20°.

In some embodiments, the composite material prepared according to methods described herein with the inclusion of addition of a hydrophobic material and optionally, a drying or curing step result in the formation of a surface which undergoes dropwise condensation under condensing heat transfer conditions. Under these condensing conditions, the condensate liquid forms many discrete droplets rather than as a continuous film. The individual droplets grow and coalesce with ongoing condensation. The individual and coalesced droplets may move along the free surface and may be shed from the surface by translation along the surface to an edge or drainage feature. The resulting heat transfer coefficient may be increased over a similar surface which does not undergo dropwise condensation. The ratio of the heat transfer coefficient of a herein described surface and a similar untreated surface under similar condensing conditions is more than about 1× to about 1.5× greater, about 1.1 to about 1.2× greater, about 1.1 to about 1.4× greater, about 1.1 to about 1.6× greater, about 1.1 to about 1.8× greater, about 1.1 to about 2× greater, about 1.1 to about 4× greater, about 1.1 to about 10× greater, or more than about 10× greater.

In some embodiments, the composite material prepared according to methods described herein with the inclusion of addition of a hydrophobic material and optionally, a drying or curing step result in the formation of a surface which undergoes droplet ejection under condensing heat transfer conditions. Under these condensing conditions, the condensate liquid forms many discrete droplets rather than as a continuous film. The individual droplets grow and coalesce with ongoing condensation. The resulting heat transfer coefficient may be increased over a similar surface which does not undergo dropwise condensation. The action of coalescing individual droplets to form larger droplets results in ejection of the droplet from the surface rather than along the surface. The average diameter of the droplets which eject via this mechanism is indicative of the surface energy of adhesion. The average number diameter of the ejected droplets is less than about 1000 μm, about 1000 μm to about 500 μm, about 500 μm to about 200 μm, about 200 μm to about 100 μm, about 100 μm to about 50 μm, about 50 μm to about 20 μm, about 20 μm to about 10 μm, about 20 μm to about 5 μm, or about 20 μm to about 2 μm, or about 20 μm to about 1 μm, or less than about 1 μm.

In some embodiments, the composite material prepared according to methods described herein with the inclusion of addition of a hydrophobic material and optionally, a drying or curing step result in the formation of a surface which reduces the temperature at which condensed water in contact with the surface will freeze, this amount is called the freezing point depression. The amount of freezing point depression of a herein described surface and a similar untreated surface under similar conditions is more than about 0.1° C., about 0.1° C. to about 1° C., about 0.1° C. to about 5° C., about 0.1° C. to about 10° C., or more than about 10° C.

In some embodiments, the composite material prepared according to methods described herein with the inclusion of addition of a hydrophobic material and optionally, a drying or curing step result in the formation of a surface which reduces the amount of energy required to defrost a herein described surface and a similar untreated surface under similar conditions by more than about 5%, about 5% to about 10%, about 5% to about 20%, about 5% to about 40%, about 5% to about 50%, about 5% to about 75%, about 5% to about 90%, about 5% to about 95%, about 5% to about 99%, about 50% to about 60%, about 50% to about 70%, about 50% to about 80%, about 50% to about 90%, about 50% to about 95%, about 50% to about 99%, about 10% to about 20%, about 20% to about 30%, about 30% to about 40%, about 40% to about 50%, about 50% to about 60%, about 60% to about 70%, about 70% to about 80%, about 80% to about 90%, or about 90% to 99%.

### EXAMPLES

The following examples are intended to illustrate, but not limit, the invention.

### Example 1. Hierarchical Structures Via Secondary Deposit

A hierarchical nanostructured surface was formed on aluminum surfaces with primary features of nanowalls and secondary features of hemispherical caps formed on the edges and sides of the nanowalls. The surface of 1100 aluminum samples were prepared in an alkaline etch and a nitric acid de-smut to clean the surface of the aluminum. Samples were then placed in a heated bath containing 50-250 mM manganese nitrate hexahydrate and 50-250 mM hexamine for about 5 minutes to about 30 minutes to form a manganese/aluminum ceramic surface. The samples were then heated in ambient air at about 400° C. to form a mixed metal oxide. The samples were then placed in a second heated aqueous immersion bath containing about 25 to about 250 mM manganese nitrate and about 25 to about 250 mM hexamine for about 5 minutes to about 1 hour. The concentrations of manganese nitrate and hexamine in the second bath were substantially different from the concentrations of manganese nitrate and hexamine in the first bath. The aluminum samples were then heated in ambient air at about 400° C. to re-form a mixed metal oxide on the surface. The samples were made superhydrophobic by immersing them in an azeotropic ethanol/water bath containing a few drops of hexadecyltriethoxysilane and an acid catalyst for about 30 minutes to about 24 hours followed by a heating step in ambient air at about 100° C. for about 1 to about 2 hours.

When a representative sample was imaged after the first aqueous immersion bath using a scanning electron microscope, the only feature that was identified was the nanowalls with a number average critical length of about 5 μm and a characteristic width of about 50 nm to about 100 nm. The thickness of the first material was about 4 μm to about 12 μm, with a mean thickness of 6 μm. When the samples were imaged after the second aqueous immersion bath, hemispherical caps and nanowalls were identified on the surface of the material. The hemispherical caps had on average a critical diameter of about 20 nm while the nanowalls had on average a critical length of about 5 μm. The characteristic size of the pores that are visible range from about 100 nm to about 5 μm.

The samples were then subjected to a series of frosting and defrosting tests to investigate the amount of held-up water that was retained on the surface of the sample after a defrost step. The samples which had primary features of nanowalls and hemispherical caps reduced the amount of held-up water on the surface of the sample compared to both a bare aluminum sample and a sample which only had the primary features of nanowalls.

Defrost drainage is improved by materials with hierarchical structures compared to materials containing only a first material or bare materials. This was evaluated by placing flat plates of the samples on a cold plate and subjecting the samples to frosting conditions. A defrost event is then triggered and the energy required to defrost the sample is measured with a heat flux sensor. For samples with improved drainage, ice will melt at the sample interface and will fall off before all the frost is able to melt, reducing the energy required to defrost the sample. High performing samples will result in less energy required to defrost than the bare control, and can result in about 25% to about 90% reduction in energy required to defrost the sample.

For example, heat flux sensors were used to measure the energy required to defrost a 1 in² sample of an untreated aluminum and a hierarchically structured aluminum surface prepared via the method in Example 1 resulted in 53% less energy consumed for the treated sample. Frost was developed on an untreated bare aluminum surface and a hierarchically structured superhydrophobic sample by subjecting them to a flowing air stream controlled to a temperature of about 2° C. and a relative humidity of 80%. The surface of the samples was held at a temperature of about −18° C. with the use of a Peltier cooler. The samples were subjected to the frosting conditions for about 25 minutes each. The defrost event was triggered by turning off the air stream and the Peltier device and allowing the samples to heat up to a temperature of about 5° C. initiating a defrost event. Heat flux through the 1 in² heat flux sensors attached to the back of the samples was tracked during this time which resulted in a sharp peak corresponding to the energy required to melt the water on the surface.

### Example 2. Hierarchical Structures Via Top Coat

A hierarchical nanostructured surface was formed on aluminum surfaces with primary features of nanowalls and secondary features of branched aggregates. The surface of 1100 aluminum samples were prepared in an alkaline etch and a nitric acid de-smut to clean the surface of the aluminum. Samples were then placed in a heated bath containing about 50 to about 250 mM manganese nitrate hexahydrate and about 50 to about 250 mM hexamine for about 5 minutes to about 30 minutes to form a manganese/aluminum ceramic surface. The nanostructured aluminum surfaces were then dip coated into this solution and heat treated at 400 C for 1 hour to form a mixed metal oxide surface. The samples were placed into a solution containing a variety of monomers and oligomers of polyurethanes at concentrations of about 30 g/L to about 110 g/L along with a cross-linker at concentrations of about 7.5 g/L to about 25 g/L. The pH of the solution was adjusted to 5.5 with acetic acid. The samples were immersed for about 2 minutes and then dried at about 160° C. for about 3 minutes. Images of the samples were taken with SEM, and primary and secondary structures were identified. The primary structures were mixed metal oxide nanowalls with a number average critical dimension of about 2 μm. The thickness of the first material varied to 2 μm to about 12 μm with a mean thickness of 6 μm. Secondary structures were also identified which showed a tree-branch geometry with primary feature sizes ranging from about 0.02 μm to about 20 μm. The samples were superhydrophobic as measured with a sessile drop measurement with a contact angle of 150°.

### Example 3. Hierarchical Structures Via Silica Deposition

A hierarchical nanostructured surface was formed on aluminum surfaces with primary features of nanowalls and secondary features of fumed silica aggregates of about 10 to about 30 μm in length. The surface of 1100 aluminum samples were prepared in an alkaline etch and a nitric acid de-smut to clean the surface of the aluminum. Samples were then placed in a heated bath containing about 50 to about 250 mM manganese nitrate hexahydrate and about 50 to about 250 mM hexamine for about 5 minutes to about 30 minutes to form a manganese/aluminum ceramic surface. A dispersion of hydrophilic fumed silica was created by dispersing the silica particles in ethanol or water at concentrations of about 0.1 wt % to about 10 wt % and mixing in a high shear mixer for about 10 minutes to break up the aggregates. The nanostructured aluminum surfaces were then dip coated into this solution for about 30 seconds and heat treated at about 400° C. for 1 hour to form a mixed metal oxide surface. The samples were then made superhydrophobic by immersing them in an azeotropic ethanol/water bath containing a few drops of hexadecyltriethoxysilane and an acid catalyst for about 30 minutes to about 24 hours followed by a heating step in ambient air at 100° C. for about 1 to about 2 hours.

When a representative sample was imaged after the first aqueous immersion bath using a scanning electron microscope, the only feature that was identified was the nanowalls with an average critical length of 2 μm. The thickness of the first material was about 2 μm to about 20 μm with a mean thickness of 8 μm. Silica was observed as mostly discrete with some aggregated spheres adhered to the nanowalls. Additionally, EDS measurements indicated a significantly higher amount of silicon on the surface as compared to a hydrophobic sample which did not include the fumed silica step.

The samples were placed in a wind tunnel and exposed to conditions where water would condense on the surface of the sample. Droplets of water were removed from the sample surface as a result of the nanostructured ceramic surface.

### Example 4. Hierarchical Structures Via Al(OH)₃ Dispersion

A hierarchical nanostructured surface was formed on aluminum surfaces with primary features of nanowalls and secondary features of agglomerated spheres. The surface of 1100 aluminum samples were prepared in an alkaline etch and a nitric acid de-smut to clean the surface of the aluminum. Samples were then placed in a heated bath containing about 50 to about 250 mM manganese nitrate hexahydrate and about 50 to about 250 mM hexamine for about 5 minutes to about 30 minutes to form a manganese/aluminum ceramic surface. The samples were heat treated in air at about 400° C. for about 1 hour to form a mixed metal oxide surface. A solution was created by dispersing aluminum hydroxide in an acidified ethanol solution at concentrations of about 0.05 to about 0.1 wt %. The nanostructured aluminum surfaces were then dip coated into this solution and allowed to dry at temperatures of about 20 to about 100° C. for about one hour. The samples were then made superhydrophobic by immersing them in an azeotropic ethanol/water bath containing a few drops of hexadecyltriethoxysilane and an acid catalyst for about 2 minutes and about 24 hours followed by a heating step in ambient air at about 100° C. for about 30 minutes to about 2 hours.

When a representative sample was imaged after the first aqueous immersion bath using a scanning electron microscope, the only feature that was identified was the nanowalls with a number average critical dimension of 2 μm. The thickness of the first material was about 2 μm to about 20 μm with a mean thickness of 8 μm. When a representative sample was imaged after the aluminum hydroxide dispersion bath, spherical agglomerates were identified on the surface composed of aluminum hydroxide. The critical diameter dimension of these agglomerates was on average smaller than the critical dimension of the nanowalls. Additionally, EDS measurements indicated a higher amount of aluminum on the surface as compared to a hydrophobic sample which did not include the aluminum hydroxide step.

The samples were placed in a wind tunnel and exposed to conditions where water would condense on the surface of the sample. Droplets of water were removed from the sample surface as a result of the nanostructured ceramic surface. In this test, there was no evidence that the silica was removed from the surface of the sample.

### Example 5. Hierarchical Structures Via Al(OH)₃ Dispersion in Top Coat

A hierarchical nanostructured surface was formed on aluminum surfaces with primary features of nanowalls and secondary features of agglomerated spheres. The surface of 1100 aluminum samples were prepared in an alkaline etch and a nitric acid de-smut to clean the surface of the aluminum. Samples were then placed in a heated bath containing about 50 mM to about 250 mM manganese nitrate hexahydrate and about 50 mM to about 250 mM hexamine for about 5 minutes to about 30 minutes to form a manganese/aluminum ceramic surface. The samples were heat treated in air at about 400° C. for about 1 hour to form a mixed metal oxide surface. A solution was created by dispersing aluminum hydroxide in an acidified ethanol solution at concentrations of about 0.05 wt % to about 0.1 wt % along with a few drops of hexadecyltriethoxysilane. The nanostructured aluminum surfaces were then dip coated into this solution for about 30 minutes to about 24 hours, and annealed at about 100° C. for about 30 minutes to about 2 hours.

When a representative sample was imaged after the first aqueous immersion bath using a scanning electron microscope, the only feature that was identified was the nanowalls with a number average critical length dimension of 2 μm. The first material had a thickness ranging from about 2 μm to about 20 μm with a mean thickness of 5 μm. When a representative sample was imaged after the aluminum hydroxide dispersion bath, spherical agglomerates were identified on the surface composed of aluminum hydroxide. The critical dimension of these agglomerates was on average smaller than the critical dimension of the nanowalls. Additionally, EDS measurements indicated a higher amount of aluminum on the surface as compared to a hydrophobic sample which did not include the aluminum hydroxide step.

The samples were placed in a wind tunnel and exposed to conditions where water would condense on the surface of the sample. Droplets of water were removed from the sample surface as a result of the nanostructured ceramic surface. There was no evidence that the alumina hydroxide was removed from the surface due to the condensation process.

The samples which were processed in the above conditions and showed improved droplet mobility with an apparent rolling angle of about 10° to about 40° of condensed droplets compared to a similar bare panel which was subjected to an alumina dispersion but did not have a nanostructured ceramic layer. The agglomerated spheres which are present on the top surface are composed of alumina hydroxide particles which partially intrude the nanostructured layer beneath, and are well adhered to the surface as they are not removed during subsequent condensation testing.

### Example 6. Hierarchical Structures Via Secondary Deposit with Higher Flow Rates

A hierarchical nanostructured surface was formed on aluminum surfaces with primary features of nanowalls and secondary features of needles formed on the edges and sides of the nanowalls. The surface of 1100 aluminum samples were prepared in an alkaline etch and a nitric acid de-smut to clean the surface of the aluminum. Samples were then placed in a heated bath containing about 50 mM to about 250 mM manganese nitrate hexahydrate and about 50 mM to about 250 mM hexamine for about 5 minutes to about 30 minutes to form a manganese/aluminum ceramic surface. The solution was pumped through a series of educators at the tank bottom to produce uniform temperature and concentration in the bath. The samples were then heated in ambient air at about 400° C. to form a mixed metal oxide. The samples were then placed in a second heated aqueous immersion bath containing about 50 to about 250 mM manganese nitrate and about 50 to about 250 mM hexamine for about 5 minutes to about 1 hour. The concentrations of manganese nitrate and hexamine in the second bath were substantially different from the concentrations of manganese nitrate and hexamine in the first bath. The second bath was pumped through a series of educators in the tank to produce uniform temperature and concentration in the bulk of the bath. The aluminum samples were then heated in ambient air at about 400° C. to re-form a mixed metal oxide on the surface. The samples were made superhydrophobic by immersing them in an azeotropic ethanol/water bath containing a few drops of hexadecyltriethoxysilane and an acid catalyst for about 2 minutes to about 24 hours followed by a heating step in ambient air at about 100° C. for about 1 hour.

When a representative sample was imaged after the first aqueous immersion bath using a scanning electron microscope, the only feature that was identified was the nanowalls with a number average critical length dimension of 5 μm. The first material had thickness ranging from about 3.5 μm to about 15 μm with a mean thickness of 5 μm. When the samples were imaged after the second aqueous immersion bath, needles and nanowalls were identified on the surface of the material. The needles had a number average a critical length of 20 nm and aspect ratio of about 5:1 to about 20:1 length: diameter while the nanowalls had on average a critical length dimension of 5 μm. The characteristic width of the nanowalls is approximately 50-100 nm. The size of the pores that are visible, range from lengths of about 10 nm to about 3 μm.

The samples were then subjected to a series of frosting and defrosting tests to investigate the amount of held-up water that was retained on the surface of the sample after a defrost step. The samples which had primary features of nanowalls and needles reduced the amount of held-up water on the surface of the sample compared to both a bare aluminum sample and a sample which only had the primary features of nanowalls.

### Example 7. Hierarchical Structures by Changing Growth Mechanics In Situ

A hierarchical nanostructured surface was formed on an aluminum heat exchanger with primary features of nanowalls and secondary features of hemispherical caps, or platelets formed on the edges and sides of the nanowalls. The surface of 1100 aluminum samples were prepared in an alkaline etch and a nitric acid de-smut to clean the surface of the aluminum. Samples were then placed in a heated bath containing about 50 mM to about 250 mM manganese nitrate hexahydrate and about 50 mM to about 250 mM hexamine for about 5 minutes to about 30 minutes to form a manganese/aluminum ceramic surface. The samples were then heated in ambient air at about 400° C. to form a mixed metal oxide. The samples were made superhydrophobic by immersing them in an azeotropic ethanol/water bath containing a few drops of hexadecyltriethoxysilane and an acid catalyst for about 2 minutes to about 24 hours followed by a heating step in ambient air at about 100° C. for about 1 hour.

When samples of the heat exchanger was imaged with an SEM, nanowalls were formed as the primary structure with a number average critical dimension of about 2 μm. Secondary structures such as platelets off the nanowalls, and hemispherical caps were formed off the nanowalls which had a range of critical dimensions of about 20 to about 200 nm.

An interconnected network of nanowalls was formed with the nanowalls primarily oriented perpendicular to the plane of the substrate. The nanowalls grow to heights of about 0.5 μm to about 15 μm with a mean of 5 μm. The length of the nanowalls is variable from about 2 μm to about 8 μm. The thickness of the primary nanowalls is 500-1000 nm. Triangular plates are grown on the edge of the nanowalls and throughout the depth of the nanowall with random orientation. The plates are about 100 nm to about 200 nm wide at their widest point and have an approximate thickness of 20 nm. The form of crystal growth is primarily random in nature so values that are outside of the range of the reported values are possible. Distributed throughout the surface of the sample are regions where the average height of the nanowalls is significantly taller than the bulk surface. In these regions, the height of the nanowall growth can reach 2-3× the average bulk height of the nanostructured surface. In these regions, the nanowalls will grow with orientations that are no longer highly perpendicular to the surface and will instead bloom out similar to a rose flower. The geometries of the secondary features in these regions is unchanged compared to the bulk nanowall coating. The flower-like blooms remained primarily interconnected to the bulk nanostructured coating even though they grew to a taller height than the rest of the surface. The flower-like blooms appear frequently throughout the sample surface with a relatively constant average density

The primary structures of the nanowalls leave significant gaps in the overall structure which increases the perceived porosity of the outer layer. With the secondary growth mechanics of the plates, and the thickening of the nanowalls, a significant amount of the overall surface porosity is eliminated because of the thickening of the walls and outward growth of the platelets.

Processing gradients of about 1 to about 20% of concentrations, temperatures and local flow velocity based on overall fluid flow rates across the heat exchanger resulted in changes of morphology across the entirety of the heat exchanger. A variety of different nanostructures with different primary and secondary features were formed on the surface of the heat exchanger. When the heat exchanger was subjected to frosting tests in a wind tunnel, the heat exchanger took on average 10× longer to reach a critical pressure drop threshold than a bare aluminum coil comparison which demonstrates significant anti-frost properties may be realized from these different morphologies tested on a single heat exchanger unit.

An interconnected network of nanowalls was formed with the nanowalls primarily oriented perpendicular to the plane of the substrate. The nanowalls grow to heights of about 0.5 μm to about 10 μm. The length of the nanowalls is variable in the 2-8 μm range. The thickness of the primary nanowalls is 500-1000 nm. Triangular plates are grown on the edge of the nanowalls and throughout the depth of the nanowall with random orientation. The plates are about 100 nm to about 200 nm wide at their widest point and have an approximate thickness of 20 nm. The form of crystal growth is primarily random in nature so values that are outside of the range of the reported values are possible.

Distributed throughout the surface of the sample are regions where the average height of the nanowalls is significantly taller than the bulk surface. In these regions, the height of the nanowall growth can reach 2-3× the average bulk height of the nanostructured surface. In these regions, the nanowalls will grow with orientations that are no longer highly perpendicular to the surface and will instead bloom out similar to a rose flower. The geometries of the secondary features in these regions is unchanged compared to the bulk nanowall coating. The flower-like blooms remained primarily interconnected to the bulk nanostructured coating even though they grew to a taller height than the rest of the surface. The flower-like blooms appear frequently throughout the sample surface with a relatively constant average density

The primary structures of the nanowalls leave significant gaps in the overall structure which increases the perceived porosity of the outer layer. With the secondary growth mechanics of the plates, and the thickening of the nanowalls, a significant amount of the overall surface porosity is eliminated because of the thickening of the walls and outward growth of the platelets.

Cross-sectional SEM imaging identified a structure with an approximate maximum height of 15 μm measured from the substrate interface. The surrounding area has an average height of about 5 μm measured from the substrate interface. In this image, we see that the nanowalls in the bulk are primarily oriented perpendicularly from the surface. In the bloom though, dendritic growth is observed where additional nanowalls appear to grow out of existing nanowalls similar to branches on a tree. These branched nanowalls are no longer always perpendicularly oriented to the surface and in fact appear to take on the full spectrum of growths from perpendicular to parallel to the substrate surface. An interfacial layer between the substrate and first material is an aluminum oxide layer of about 0.1 μm to about 1 μm which is formed. The typical width for the nanowalls is in the 20-100 nm range.

### Example 8. Hierarchical Structures Formed Via Active Changing of the Growth Mechanics In Situ

A hierarchical nanostructured surface is formed on an aluminum surface with primary features of nanowalls and secondary features of hemispherical caps, or platelets formed on the edges and sides of the nanowalls. The surface of 1100 aluminum samples is prepared in an alkaline etch and a nitric acid de-smut to clean the surface of the aluminum. Samples are placed in a heated bath containing about 50 mM to about 250 mM manganese nitrate hexahydrate and about 50 mM to about 250 mM hexamine for about 5 minutes to about 30 minutes to form a manganese/aluminum ceramic surface. Local crystallization mechanics are impacted by changing the local process conditions such as changing the temperature of the bath, changing the local fluid flow in the bath, substantially increasing the concentration of one or both of the reactive components, or substantially decreasing the concentration of one or both of the reactive components. The samples are heated in ambient air at about 400° C. to form a mixed metal oxide. The samples are made superhydrophobic by immersing them in an azeotropic ethanol/water bath containing a few drops of hexadecyltriethoxysilane and an acid catalyst for about 2 minutes to about 24 hours followed by a heating step in ambient air at about 100° C. for about 1 hour.

When samples of the heat exchanger are imaged with an SEM, nanowalls are formed as the primary structure with a number average critical length of about 5 μm. Secondary structures such as platelets off the nanowalls, and hemispherical caps are formed off the nanowalls which have an average critical diameter dimension of about 5 nm to about 20 nm.

### Example 9. Modified Chemistry

A hierarchical nanostructured surface is formed on aluminum surfaces with primary features of nanowalls and secondary features of spherical particles with an average critical dimension of about 200 nm in diameter which are adhered to the top surface of the nanowalls. The surface of 1100 aluminum samples is prepared in an alkaline etch and a nitric acid de-smut to clean the surface of the aluminum. Samples are then placed in a heated bath containing about 50 mM to about 250 mM manganese nitrate hexahydrate and about 50 mM to about 250 mM hexamine for about 2 minutes to about 30 minutes to form a manganese/aluminum ceramic surface. The samples were then heated in ambient air at about 105° C. to about 200° C. to form a mixed metal oxide. The samples are then placed in a second heated aqueous immersion bath containing about 1.1 mol % ammonium acetate, about 0.13 mol % manganese acetate, about 10 mol % acetic acid, about 0.01 mol % ammonium persulfate, and about 0.01% sulfuric acid. The aluminum samples are then heated in ambient air at about 100° C. to about 200° C. to re-form a mixed metal oxide containing manganese and aluminum oxides on the surface. The samples are made superhydrophobic by immersing them in an azeotropic ethanol/water bath containing a few drops of hexadecyltriethoxysilane and an acid catalyst for about 2 minutes to about 24 hours followed by a heating step in ambient air at about 100° C. for about 1 hour.

When a representative sample is imaged after the first aqueous immersion bath using a scanning electron microscope, the only feature that was identified was the nanowalls with a number average critical length dimension of about 5 μm. When the samples are imaged after the second aqueous immersion bath, spherical particles were identified on the surface of the material. The spherical particles had a number average a critical dimension of about 200 nm in diameter while the nanowalls have on average a critical length dimension of about 2 μm.

The samples are then subjected to a series of frosting and defrosting tests to investigate the amount of held-up water that is retained on the surface of the sample after a defrost step. The samples which have primary features of nanowalls and spherical particles reduce the amount of held-up water on the surface of the sample compared to both a bare aluminum sample and a sample which only has the primary features of nanowalls.

### Example 10. Different Length Scale Structures Grown Via Substrate Thermal Treatment

A hierarchical nanostructured surface is formed on aluminum surfaces with primary features of flower-blooms and secondary features of nanowalls. The aluminum substrate is a precipitation hardened surface such as a 6xxx or 7xxx series aluminum. The precipitation hardening step will crystallize intermetallic particles in the aluminum substrate and disperse these throughout the substrate. The surface of the aluminum is placed in an alkaline etch and a nitric acid de-smut bath to clean the surface of the aluminum. Samples are then placed in an aqueous heated bath containing about 50 mM to about 250 mM manganese nitrate hexahydrate, about 50 to about 250 mM hexamine for about 2 minutes to about 60 minutes to form a manganese/aluminum ceramic surface. The samples are heated in ambient air at about 400° C. for about 5 minutes to about 1 hour to form a mixed metal oxide surface on the substrate. The samples are made superhydrophobic by immersing them in an azeotropic ethanol/water bath containing a few drops of hexadecyltriethoxysilane and an acid catalyst for about 2 minutes to about 24 hours followed by a heating step in ambient air at about 100 C for about 1 hour.

When a representative sample is imaged with a scanning electron microscope there are two different primary features that are formed. One of the primary features is flower-like blooms on the surface of the aluminum which are the result of the intermetallic particles. These intermetallic particles locally catalyze the growth mechanics of the metal oxide system resulting in blooms that are about 2 to about 3× taller than the surrounding sample surface, the intermetallic particles are controllably precipitated in the precipitation hardening process and serve as nucleation sites for the bloom structures. The secondary features that are observed in this sample are nanowalls which have a primary dimension of about 2 μm to about 10 μm and an approximate thickness of about 20 to about 100 nm.

By controlling the surface density of the intermetallic particles and the growth kinetics of the surface, a patterned nanostructured surface is formed with floral blooms ranging from about 20 μm to about 100 μm in diameter spaced about 50 to about 100 μm apart uniformly across the surface. These blooms are about 2 to about 3× taller than the bulk surface which creates a patterned surface without the use of lithographic techniques. Prior to immersing the sample in the aqueous bath containing hexamine and manganese nitrate, the sample is not intentionally patterned, but the surface of the sample after the deposition process includes a pattern which creates a more hydrophobic surface compared to a uniform nanostructured coating.

### Example 11. Hierarchical Structures Via Secondary Precipitation Based Deposit

A hierarchical nanostructured surface was formed on aluminum surfaces with primary features of nanowalls and secondary features aggregates of precipitation reactions formed on the edges and sides of the nanowalls, occupying space within the nanowall structures and pores. The surface of aluminum samples were prepared in an alkaline etch and a nitric acid de-smut or other surface treatment processes to clean the surface of the aluminum. Samples were then placed in a heated bath containing 10-250 mM zinc metal nitrate hexahydrate and 10-250 mM hexamine for about 5 minutes to about 90 minutes to form a zinc metal/aluminum ceramic surface. The samples were then dried in air at temperatures between about 100° C. to about 450° C. The samples were then contacted with a precipitation reaction reagent at laboratory temperature of 20° C. to 25° C. to distribute the reagent throughout the primary structure. The samples were then contacted with a second precipitation reaction reagent at laboratory temperature of 20° C. to 25° C. for about 30 seconds to 20 minutes. The initial precipitation reagents comprised a soluble metal salt such as calcium nitrate, at or around 25 mM. The sample was optionally dried to promote uniform distribution of the metal salt. The second precipitation reaction reagent comprised a soluble phosphate, sulfate, oxalate or other soluble anion containing reagent such as a solution at or around 15 mM potassium phosphate [K₂H(PO₄)]. The samples were then subsequently dried in air at 40° C., 120° C. and 400° C. for 5 to 30 minutes. Each of the samples showed the formation of aggregates of the precipitation reaction occupying the space formed by the nanowall structure. A representative sample was imaged after the first aqueous immersion bath using a scanning electron microscope, the only feature that was identified are nanowalls with a number average critical length of about 5 μm and a characteristic width of about 50 nm to about 100 nm. The thickness of the first material was about 2 μm to about 12 μm, with a mean thickness of 4 μm. When the samples were imaged after immersion of a primary precipitation reaction reagent, no precipitation reaction agglomerates were identified. After immersion into a secondary precipitation reaction reagent, agglomerates of the precipitation reaction product were observed as secondary features within the nanowall structures. The aggregates have an average critical diameter smaller than the characteristic dimension of the nanowalls.

The precipitation reaction rate determines the size of the aggregates, and may be controlled by controlling reagent concentrations or reaction temperatures. Typical temperatures range from 20° C. to 90° C. and concentrations of 1 mM to 1M. Reaction times range from about 30 seconds to 30 minutes. The samples with secondary precipitation reactants can optionally be heated to the melting point of the substrate to further fuse and bind the precipitation reactants. For example, metal substrates may be heated from about 100° C. to about 600° C. for 1 to 60 minutes. The samples can optionally be made superhydrophobic by immersing them into solution that results in a surface with high surface energy as measured by contact angle.

### Example 12. Hierarchical Structures Via Secondary Conversion Reaction

A hierarchical nanostructured surface was formed on aluminum surfaces with primary features of nanowalls and secondary features of smaller nanowalls grown out of the primary nanowalls which occupy the space within the primary nanowall structure and pores. The surface of the aluminum samples were prepared in an alkaline etch and a nitric acid de-smut or other surface treatment processes to clean and prepare the surface of the aluminum. Samples were then placed in a heated bath containing about 10 mM to about 350 mM magnesium nitrate hexahydrate and about 10 mM to about 350 mM hexamine for about 5 minutes to about 90 minutes to form a magnesium/aluminum ceramic surface with primary features of nanowalls. The samples were then optionally dried in air at temperatures between about 25° C. to about 400° C. The samples were then placed into an aqueous bath containing sodium bicarbonate at concentrations between about 50 mM and about 150 mM at temperatures between about 20° C. to about 80° C. for times between about 15 minutes to about 24 hours. The samples were then dried in ambient laboratory air.

A representative sample was collected after the first aqueous immersion bath using a scanning electron microscope. The only feature that was identified are nanowalls oriented primarily perpendicular to the substrate surface with a number average critical length of about 5 μm and a characteristic width of about 50 nm to about 100 nm. The thickness of the first material was about 2 μm to about 12 μm, with a mean thickness of 4 μm. When the samples were imaged after the second aqueous immersion bath, the primary features identified from bath 1 were still present, and additional features of nanowalls with a number average critical length of about 200 nm and a characteristic width of about 10 nm to about 50 nm. The smaller nanowalls formed in the second immersion step are formed out of the walls of the larger nanowalls forming a hierarchical structure.

A version of this process was prepared on 2024 aluminum alloys. These samples were placed in an accelerated corrosion environment according to ASTM B117 standard where sodium chloride salt is sprayed on the samples to corrode the metal. Bare aluminum controls were placed in the chamber along with samples with just the primary structure and samples with the secondary structure as well. The bare 2024 aluminum samples exhibited substantial pitting corrosion after 168 hours. The samples with just the primary structure exhibited improved performance than the bare, but some pitting corrosion was observed on the samples. The samples with hierarchical structures exhibited no corrosion on the surface of the material demonstrating that samples with hierarchical structures improved the corrosion resistance of the coated materials compared to both the primary structure alone and compared to the bare aluminum.

### Example 13

Hierarchical nanoparticles are formed in an aqueous solution via a precipitation reaction with primary features of nanowalls and secondary features of stellated particles which are formed on the edges and sides of the nanowalls, occupying space within the nanowall structures and pores. The first material is composed of manganese oxide and is formed via a precipitation reaction. An aqueous bath is heated to 80° C. and contains 25-150 mM manganese nitrate hexahydrate and 25-150 mM hexamethylenetetramine. The solution is stirred continuously for 4 hours and brown precipitates are formed in the bath comprising Mn₃O₄. The precipitates are separated from the solution via vacuum filtration and washed thoroughly with de-ionized water to remove any water soluble compounds. The precipitates are then dried in a convection oven at 60° C. for 24 hours. When the precipitates are imaged in an SEM after the drying step, the particles have a characteristic diameter of 30-50 μm and have primary features of nanowalls. The nanowalls have a characteristic length ranging from about 1-10 μm and an average of 4 μm. The particles are then placed in an ambient temperature aqueous bath containing calcium nitrate at a concentration of 25 mM. The particles are placed in the solution for 1 hour to allow the solution to penetrate the pores of the nanoparticles and are then filtered out of the solution and dried at 50° C. for 1 hour in a convection oven. The nanoparticles are not washed prior to drying. The nanoparticles are then placed in a small glass vial at ambient conditions and a 100 mM solution of potassium phosphate monobasic is added to the nanoparticles with just enough fluid to fully wet the nanoparticles, approximately 1 mL forming a precipitate of calcium phosphate material (e.g., hydroxyapatite) inside of the nanoparticles. The nanoparticles are then dried in a convection oven at 50° C. for one hour. The nanoparticles are imaged in an SEM and the particles have a characteristic diameter of 30-50 μm and have primary features of nanowalls. The nanowalls maintain a characteristic length ranging from 1-10 μm with an average of 4 μm. There are additional secondary features of stellated particles on the edges and sides of the nanowalls occupying the void space left by the nanowalls. These stellated particles have a characteristic dimension of 100-500 nm and are adhered to the primary particles.

Although the foregoing invention has been described in some detail by way of illustration and examples for purposes of clarity of understanding, it will be apparent to those skilled in the art that certain changes and modifications may be practiced without departing from the spirit and scope of the invention. Therefore, the description should not be construed as limiting the scope of the invention, which is delineated in the appended claims.

All publications, patents, and patent applications cited herein are hereby incorporated by reference in their entireties for all purposes and to the same extent as if each individual publication, patent, or patent application were specifically and individually indicated to be so incorporated by reference.

1. A composition comprising a substrate, a first material, and a second material,
wherein the first material comprises a porous, nanostructured ceramic that comprises pores and the second material comprises particles,
wherein the second material particles at least partially occupy at least a portion of the pores of the first material, and
wherein the substrate is in contact with at least a portion of the first material.

2. (canceled)

3. The composition according to claim 1, wherein the first material comprises a transition metal, an alkaline earth metal, or a rare earth metal.

4. The composition according to claim 1, wherein the first material comprises a metal oxide, a metal hydroxide, or a layered double hydroxide.

5. The composition according to claim 1, wherein the first material comprises zinc, iron, manganese, magnesium, calcium, nickel, or cerium.

6. The composition according to claim 1, wherein the first material comprises a thickness of about 10 nanometers to about 200 micrometers or about 20 nanometers to about 50 nanometers.

7.-8. (canceled)

9. The composition according to claim 1, wherein the substrate comprises a metal comprising aluminum, iron, zinc, manganese, magnesium, copper, nickel, vanadium, and/or silicon, wherein the substrate comprises a ceramic comprising aluminum, iron, zinc, silicon, oxygen, and/or carbon, or wherein the substrate comprises a polymer comprising aluminum, silicon, oxygen, nitrogen, phosphorous, sulfur, fluorine, and/or carbon.

10. The composition according to claim 1, wherein the second material comprises particles with a characteristic dimension less than about 20 micrometers, less than about 10 micrometers, less than about 5 micrometers, less than 2 micrometers, less than 1 micrometer, less than 500 nanometers, less than about 250 nanometers, or less than about 100 nanometers.

11. The composition according claim 1, wherein the second material comprises a transition metal, an alkaline earth metal, or a rare earth metal.

12. The composition according to claim 1, wherein the second material comprises a metal oxide, a metal hydroxide, or a layered double hydroxide.

13. The composition according to claim 1, wherein the second material comprises zinc, iron, manganese, magnesium, calcium, nickel, or cerium.

14. The composition according to claim 1, wherein at least a portion of the second material comprises a thickness of about 10 nanometers to about 20 micrometers.

15. (canceled)

16. The composition according to claim 1, wherein the second material comprises an inorganic metal salt, a mineral, or a metal containing precipitation reaction product.

17. (canceled)

18. The composition according to claim 1, wherein the second material comprises silica, fumed silica, a silicone, a silane, a siloxane, a polysiloxane, a silazane, or a polysilazane.

19. The composition according to claim 1, wherein the second material comprises particles of aluminum oxide, aluminum oxide-hydroxide or mixed oxide phase, aluminum trihydroxide, aluminum chalcogenide, or aluminum pnictide.

20. The composition according to claim 1, wherein the second material comprises any of Sc, Ti, V, Cr, Mn, Fe, Co, Ni, Cu, or Zn, or any of Y, Zr, Nb, Mo, Tc, Ru, Rh, Pd, Ag, or Cd, or any of Lu, Hf, Ta, W, Re, Os, Ir, Pt, Au, or Hg, or any of Lr, Rf, Db, Sg, Bh, Hs, Mt, Ds, Rg, or Cn.

21. The composition according to claim 1, wherein the second material comprises any of Ca, Mg, Ba, Sc, Li, Be and an associated phosphate, carbonate, oxalate, fluoride, or sulfate.

22. The composition according to claim 1, wherein the substrate and the second material comprise at least one common element comprising Cu, Mn, Fe, Al, Si, Zn, Mg, Ti, Ni, or Zr.

23. (canceled)

24. The composition according to claim 1, comprising an interface between the first material and the second material, wherein the interface comprises a gradient with an interfacial composition or morphology.

25. (canceled)

26. The composition according to any of claim 1, wherein the composition is charactered by a sessile drop water contact angle above 150 degrees.

27. The composition according to claim 1, wherein the composition further comprises a hydrophobic compound with a polar head group and a non-polar tail group comprising an alkyl group, a methyl group, a fluoroalkyl group, a perfluoroalkyl group, a vinyl group, a phenyl group, a substituted alkyl group, or an aryl group.

28. The composition according to claim 1, wherein the composition comprises about 5%, about 5% to about 10%, about 5% to about 20%, about 5% to about 40%, about 5% to about 50%, about 5% to about 75%, about 5% to about 90%, about 5% to about 95%, about 5% to about 99%, about 50% to about 60%, about 50% to about 70%, about 50% to about 80%, about 50% to about 90%, about 50% to about 95%, about 50% to about 99%, about 10 to about 20%, about 20 to about 30%, about 30% to about 40%, about 40% to about 50%, about 50% to about 60%, about 60% to about 70%, about 70% to about 80%, about 80% to about 90%, or about 90% to 99% reduction in defrost energy requirement to remove frost which has formed when compared to an identical substrate that does not comprise the composition or an identical first material in which the pores are not occupied by the second material.

29. A method to produce a composition according to claim 1, said method comprising:
(a) contacting a substrate with an aqueous solution that comprises at least one metal salt and at least one amine to produce a first material comprising a ceramic crystal structure on a surface of the substrate, thereby producing a coated substrate comprising the first material deposited on the substrate;
(b) contacting the coated substrate with a nanoparticle dispersion of an insoluble oxide and/or hydroxide of a metal or a metalloid, thereby producing a second material deposited on the first material;
(c) removing the coated substrate from the nanoparticle dispersion and optionally, baking it to remove water from surfaces of the coated substrate; and
(d) optionally, coating the coated substrate with a hydrophobic compound, thereby producing a hydrophobic coated substrate.

30. The method according to claim 29, wherein the oxide and/or hydroxide in (b) comprises titanium oxide, aluminum oxide, aluminum hydroxide, silica, zinc oxide, iron oxide, zirconium dioxide, and/or manganese oxide.

31. The method according to claim 29, where the number average diameter of the nanoparticles in the nanoparticle dispersion is about 50 nm to about 50 μm.

32. A method to produce a composition according to claim 1, said method comprising:
(a) contacting a substrate with an aqueous solution that comprises at least one metal salt and at least one amine to produce a first material comprising a ceramic crystal structure on a surface of the substrate, thereby producing a coated substrate comprising the first material deposited on the substrate;
(b) contacting the coated substrate with a solution that comprises a first precipitation reagent, thereby distributing the precipitation reagent throughout at least a portion of the first material, and then contacting the coated substrate with a solution that comprises a second precipitation reagent, thereby producing a second material deposited on the first material;
(c) removing the coated substrate from the solutions that comprise the first and second precipitation reagents, and optionally, drying the coated substrate to remove water from surfaces of the coated substrate; and
(d) optionally, coating the coated substrate with a hydrophobic compound, thereby producing a hydrophobic coated substrate.

33. The method according to claim 32, wherein the first precipitation reagent comprises a metal salt and the second precipitation reagent comprises a complementary cation comprising phosphate, carbonate, oxalate, fluoride, or sulfate.

34. The method according to claim 33, wherein the precipitation reaction produces nanoparticles with a number average diameter of about 50 nm to about 50 μm.

35. A method to produce a composition according to claim 1, said method comprising:
(a) contacting a substrate with a first aqueous solution that comprises at least one metal salt and at least one amine to produce a first material comprising a ceramic crystal structure on a surface of the substrate, thereby producing a coated substrate comprising the first material deposited on the substrate, and removing the coated substrate from the first aqueous solution and optionally, baking it to remove water from surfaces of the coated substrate;
(b) contacting the coated substrate with a second aqueous solution that comprises at least one metal salt and at least amine, thereby producing a second material comprising a ceramic crystal structure deposited on the first material;
(c) removing the coated substrate from the second aqueous solution and optionally, baking it to remove water from surfaces of the coated substrate; and
(d) optionally, coating the coated substrate with a hydrophobic compound, thereby producing a hydrophobic coated substrate.

36. The method according to claim 35, wherein the metal salt(s) in the first and second aqueous solutions comprise the same chemical composition.

37. The method according to claim 35, wherein the metal salt(s) in the first and second aqueous solutions comprise different chemical compositions.

38. The method according to claim 36, wherein the metal salt(s) in the first and/or second aqueous solution comprises zinc, manganese, cobalt, nickel, aluminum, copper, iron, magnesium, titanium, and/or zirconium.

39. The method according to claim 35, wherein step (a) and step (b) comprise different crystallization conditions, comprising different of the method comprise different time, concentrations of metal salt(s) and/or amine(s), and/or temperature for said contacting with the first and second aqueous solutions.

40. A method to produce a composition according to claim 1, said method comprising:
(a) contacting a substrate with an aqueous solution comprising at least one metal salt and at least one amine to produce a first material comprising a ceramic crystal structure on a surface of the substrate, thereby producing a coated substrate comprising the first material deposited on the substrate, and removing the coated substrate from the first aqueous solution and optionally, baking it to remove water from surfaces of the coated substrate;
(b) contacting the coated substrate with a solution comprising a particulate material, optionally at a temperature of about 20° C. to about 90° C. for a duration of about 0.5 minutes to about 2 hours, such that a second material comprising particulate aggregates is deposited on the first material;
(c) removing the coated substrate from the aqueous solution and optionally, baking it to remove water from surfaces of the coated substrate; and
(d) optionally, coating the coated substrate with a hydrophobic compound, thereby producing a hydrophobic coated substrate.

41. A method to produce a composition according to claim 1, said method comprising:
(a) contacting a substrate with a first aqueous solution that comprises at least one metal salt and at least one amine to produce a first material comprising a ceramic crystal structure on a surface of the substrate, thereby producing a coated substrate comprising the first material deposited on the substrate; and
(b) contacting the coated substrate with a second aqueous solution that comprises a metal salt, thereby producing a second material deposited on the first material,
wherein the first material and the second material are primarily crystalline, and
wherein between steps (a) and (b), the substrate containing the first material is dried in air at a temperatures of about 20° C. to about 450° C. for a time period of about 1 minute to about 120 minutes.

42. (canceled)

43. The composition according to claim 1, wherein the first material comprises a porous, nanostructured ceramic with a morphology comprising nanowalls and the second material comprises a morphology comprising at least one of spheres, rods, plates, needles, sheets, grains, spheres with colpi, polyhedra, toroidal shapes, stellated shapes, and conical sections.
